(19) United States
(12) Patent Application Publication
(10) Pub. No.: US 2016/0026113 A1
(43) Pub. Date: Jan. 28, 2016

(54) DEVELOPING DEVICE AND IMAGE FORMING APPARATUS

(71) Applicants: Yutaka TAKAHASHI, Yokohama (JP); Toshio KOIKE, Machida (JP); Keinosuke KONDOH, Atsugi (JP); Akihiro KAWAKAMI, Shinagawa (JP); Kentaro MIKUNIYA, Setagaya (JP)

(72) Inventors: Yutaka TAKAHASHI, Yokohama (JP); Toshio KOIKE, Machida (JP); Keinosuke KONDOH, Atsugi (JP); Akihiro KAWAKAMI, Shinagawa (JP); Kentaro MIKUNIYA, Setagaya (JP)

(21) Appl. No.: 14/749,928

(22) Filed: Jun. 25, 2015

(30) Foreign Application Priority Data
Jul. 28, 2014 (JP) 2014-152904

(51) Int. Cl. G03G 15/08

(52) U.S. Cl. CPC G03G 15/0806

(57) ABSTRACT

A developing device includes a developer including a toner, a developer carrier to carry the developer to an image forming area opposing to a latent image bearing member with rotate, a development casing storing the developer, and a developing bias applying member to apply a developing bias to the developer carrier. There is a contacting part to contact a contacting member grounded electrically and disposed at the development casing, and a gap adjusting member to form a gap between the gap adjusting member and the developing carrier. The gap adjusting member is disposed downstream of a rotating direction of the developer carrier. The development casing is conductive, and an insulation member to insulate the gap adjusting member from the development casing is disposed between the gap adjusting member and the development casing.

### CROSS-REFERENCE TO RELATED APPLICATION

This patent application is based on and claims priority pursuant to 35 U.S.C. §119(a) to Japanese Patent Application No. 2014-152904, filed on Jul. 28, 2014, in the Japan Patent Office, the entire disclosure of which is hereby incorporated by reference herein.

### BACKGROUND

1. Technical Field

Embodiments of the present invention generally relate to a developing device, and an image forming apparatus such as a copier, a printer, a facsimile machine, or a multifunction machine having at least two of copying, printing, facsimile transmission, plotting, and scanning capabilities, that includes a developing device.

2. Description of the Background

Generally, image forming apparatuses include a developing device to develop latent images formed on a latent image bearer with developer. For example, there are two-component developing devices that employ two-component developer consisting essentially of toner particles and carrier particles. In two-component developing devices, a casing to contain developer includes an opening to partly expose the surface of a developer bearer (such as a developing roller), and the exposed surface of the developing roller faces the surface of the latent image bearer (such as a photoreceptor). A magnetic field generator provided inside the developing roller generates a magnetic field to generate a magnetic brush of developer on the developing roller, and the magnetic brush contacts the photoreceptor in a range where the developing roller faces the photoreceptor. The developer bearer has applied thereto a developing bias. Thus, toner is supplied to the latent image on the photoreceptor, to develop it into a toner image by a potential difference between the latent image and the developing roller.

### SUMMARY

In view of the foregoing, one embodiment of the present invention provides a developing device includes a developer including a toner, a developer carrier to carry the developer to an image forming area opposing to a latent image bearing member with rotate, a development casing storing the developer, a developing bias applying member to apply a developing bias to the developer carrier, a contacting part to contact a contacting member grounded electrically disposed at the development casing, and a gap adjusting member to form a gap between the gap adjusting member and the developing carrier and disposed at a downstream of a rotating direction of the developer carrier. The development casing has conductivity, and an insulation member to insulate the gap adjusting member from the development casing is disposed between the gap adjusting member and the development casing.

### BRIEF DESCRIPTION OF THE SEVERAL VIEWS OF THE DRAWINGS

A more complete appreciation of the disclosure and many of the attendant advantages thereof will be readily obtained as the same becomes better understood by reference to the following detailed description when considered in connection with the accompanying drawings, wherein:

FIG. 1 is an enlarged view of a developing roller.

FIG. 2 is a schematic diagram illustrating an image forming apparatus according to an embodiment;

FIG. 3 is a schematic diagram illustrating a cooling device.

FIG. 4 is an enlarged cross-sectional view of a developing device and a photoreceptor.

FIG. 5 is a perspective view of the developing device.

FIG. 6 is a perspective view of the developing device shown in FIG. 5 without a cover attached to the upper area of developing roller.

FIG. 7 is a perspective view of a flow of the developer in a lower part of the developing device.

FIG. 8 is a perspective view of a flow of the developer in an upper part of the developing device.

FIG. 9 is a perspective cross-sectional view of the developing device to describe a flow of the developer.

FIG. 10 is a schematic diagram illustrating movement of developer.

FIG. 11 is a cross-sectional view of a casing includes three developer conveyance paths shown in FIG. 4.

FIG. 12 is side view of the developing device without a cover attached upper area of developing roller.

FIG. 13 is a side view of a developing device of a reference example.

FIG. 14 is an enlarged cross section view of a casing gap of the developing device shown in FIG. 4

FIG. 15 is a cross-sectional view of the developing device shown in FIG. 4 without a gap adjusting member and a sponge seal.

FIG. 16 is an enlarged view of a casing gap of the developing device shown in FIG. 15.

FIG. 17 is an enlarged perspective view of a rear side of the developing device without the gap adjusting member and the sponge seal.

FIG. 18 is an enlarged perspective view of a near side of the developing device without the gap adjusting member and the sponge seal.

FIG. 19 is an enlarged cross-sectional view of a border of a reference example.

FIG. 20A is a schematic view of the sponge seal protruding from two other parts.

FIG. 20B is a schematic view of the sponge seal retracting from two other parts towards an inner side.

FIG. 21 is a schematic view of lengths of each parts of the developing device.

FIG. 22 is an enlarged cross-sectional view of a border of the developing device.

FIG. 23 is a view of a deviation of the developer in a downstream of a conveyance path.

FIG. 24 is view of the developer flow at the portion where the developer is conveyed from a stirring conveyance path to upwardly toward a supply conveyance path.

FIG. 25 is a graph of a relation between a passed time of the developing device and variation of a temperature.

FIG. 26 is a drawing of the developing device before an insulating tape and the gap adjusting member is fixed to the developing device.

FIG. 27 is a cross-sectional view of the developer of a comparative example.

FIG. 28 is an enlarged view of the developing roller of a second embodiment.

FIG. 29 is an enlarged view of the developing roller of a third embodiment.

FIG. 30 is an enlarged view of the developing roller of a fourth embodiment.

FIG. 31 is an enlarged view of the developing roller of a fifth embodiment.

### DETAILED DESCRIPTION

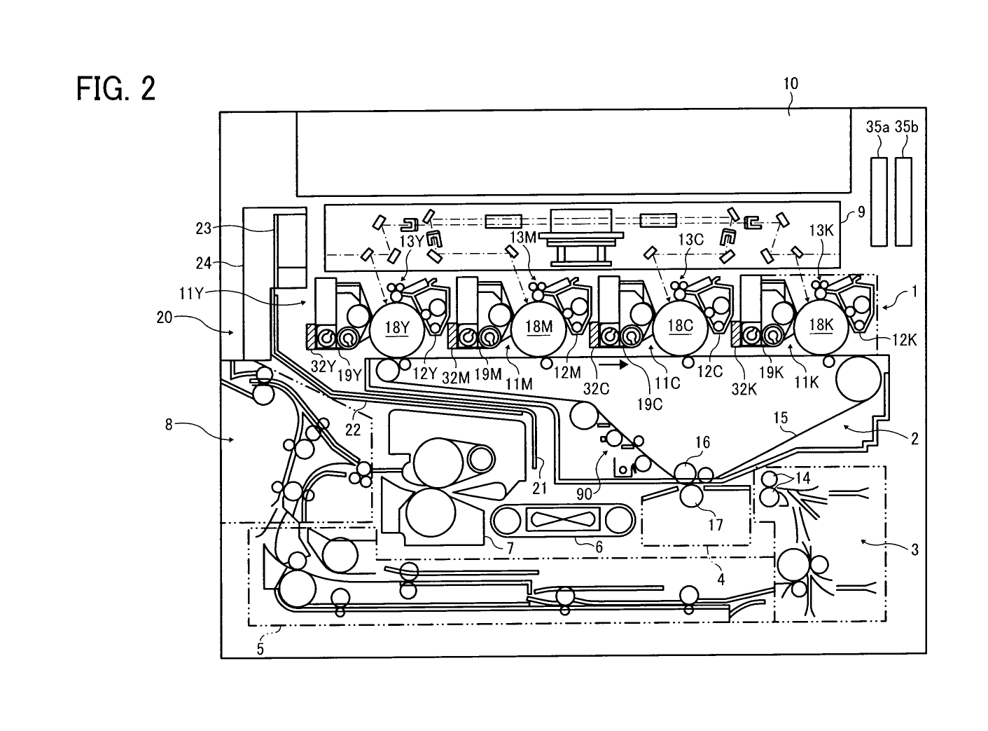

In describing illustrative embodiments illustrated in the drawings, specific terminology is employed for the sake of clarity. However, the disclosure of this patent specification is not intended to be limited to the specific terminology so selected, and it is to be understood that each specific element includes all technical equivalents that operate in a similar manner and achieve a similar result. Illustrative embodiments of the present invention are now described below with reference to the accompanying drawings. In a later-described comparative example, illustrative embodiment, and exemplary variation, for the sake of simplicity the same reference numerals will be given to identical constituent elements such as parts and materials having the same functions, and redundant descriptions thereof omitted unless otherwise required. A description is now given of a configuration and operations of an image forming apparatus according to illustrative embodiments. FIG. 2 is a schematic view illustrating an example of a configuration of an image forming apparatus according to illustrative embodiments. Referring to FIG. 2, the image forming apparatus includes an image forming part 1 in which four image forming units 11Y, 11M, 11C, and 11K are arranged in parallel to one another. The image forming units 11Y, 11M, 11C, and 11K respectively include drum-type photoconductors 18Y, 18M, 18C, and 18K, each serving as a latent image bearing member; drum cleaning units 12Y, 12M, 12C, and 12K; chargers 13Y, 13M, 13C, and 13K; and developing devices 40Y, 40M, 40C, and 40K employing a two-component developing method. The image forming units 11Y, 11M, 11C, and 11K are detachably attachable to the image forming apparatus so that consumable parts can be replaced with new ones.

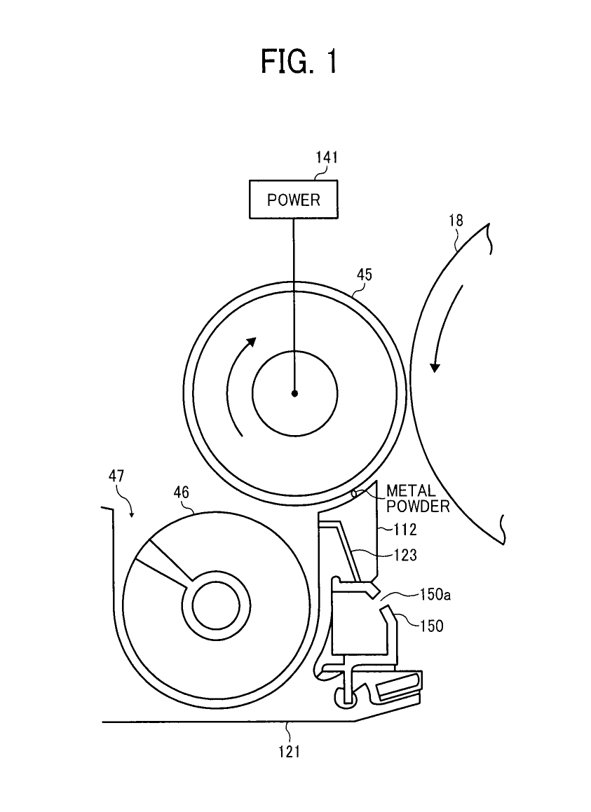

An irradiating device 9 serving as latent image forming means is provided above the image forming part 1. The image forming apparatus further includes a reading device 10 at an upper portion thereof. The reading device 10 scans a document placed on a contact glass to read the document. The reading device 10 may be implemented as any type of scanner and includes, for example, a charge couple device (CCD). A transfer device 2 including an intermediate transfer belt 15 serving as an intermediate transfer body is provided below the image forming part 1. The intermediate transfer belt 15 is wound around multiple support rollers, and is rotated in a clockwise direction in FIG. 1. A secondary transfer device 4 including a secondary transfer roller 17 is provided below the transfer device 2.

The secondary transfer roller 17 contacts an outer surface of the intermediate transfer belt 15 at a portion where the intermediate transfer belt 15 is wound around a transfer opposing roller 16, so that a secondary transfer nip is formed between the intermediate transfer belt 15 and the secondary transfer device 4. A secondary transfer bias is applied to the secondary transfer roller 17 from a power source, not shown, and the transfer opposing roller 16 is electrically grounded. Accordingly, a secondary transfer magnetic field is formed within the secondary transfer nip. The image forming apparatus further includes a fixing device 7 on the left of the secondary transfer device 4 in FIG. 1. The fixing device 7 includes a heat roller having a heat generator therein to fix a transferred toner image to a sheet.

A conveyance belt 6 is provided between the secondary transfer device 4 and the fixing device 7 to convey the sheet having the transferred toner image thereon to the fixing device 7. A paper feeder 3 is provided at a lower portion of the image forming apparatus to feed a sheet fed one by one from a sheet storage, not shown, to the secondary transfer device 4. The image forming apparatus further includes a discharge device 8 to either discharge the sheet conveyed from the fixing device 7 from the image forming apparatus or convey the sheet to a duplex device 5.

When a document is copied using the image forming apparatus, first, the document is read by the reading device 10. At the same time, the intermediate transfer belt 15 is rotated in the clockwise direction in FIG. 2. and the irradiating device 9 irradiates surfaces of the photoconductors 18Y, 18M, 18C, and 18K each charged by the chargers 13Y, 13M, 13C, and 13K using image data of specific colors of yellow, magenta, cyan, and black based on the document read by the reading device 10 to form latent images of the respective colors. Subsequently, the latent images respectively formed on the surfaces of the photoconductors 18Y, 18M, 18C, and 18K are developed by the developing devices 40Y, 40M, 40C, and 40K to form toner images of each color. The toner images thus formed on the surfaces of the photoconductors 18Y, 18M, 18C, and 18K, respectively, are sequentially transferred onto the intermediate transfer belt 15 in a superimposed manner to form a full-color toner image on the intermediate transfer belt 15. Thereafter, the surfaces of the photoconductors 18Y, 18M, 18C, and 18K after transfer of the toner images are cleaned by the drum cleaning units 12Y, 12M, 12C, and 12K to remove residual toner therefrom and be ready for the next sequence of image forming operations.

While the full-color toner image is formed as described above, sheets are fed one by one from a sheet storage. The sheet thus fed is conveyed to a pair of registration rollers 14 and is stopped at the pair of registration rollers 14. The pair of registration rollers 14 is rotated in synchronization with the full-color toner image formed on the intermediate transfer belt 15 to convey the sheet between the intermediate transfer belt 15 and the secondary transfer device 4. Accordingly, the full-color toner image is transferred onto the sheet by the secondary transfer device 4. The sheet having the full-color toner image thereon is conveyed to the fixing device 7 by the conveyance belt 6. In the fixing device 7, heat and pressure are applied to the sheet to fix the full-color toner image to the sheet. The sheet having a fixed full-color image thereon is then conveyed to the discharge device 8.

The discharge device 8 guides the sheet to either a discharge tray provided on an exterior of the image forming apparatus, or the duplex device 5 using a switching pick. The duplex device 5 reverses the sheet so that the sheet is guided to the secondary transfer nip again to form an image on a back side of the sheet. Thereafter, the sheet having the image on both sides thereof is discharged to the discharge tray by the discharge device 8. It is to be noted that the intermediate transfer belt 15, after transfer of the full-color toner image onto the sheet, is cleaned by a belt cleaning unit 90 to remove residual toner therefrom and be ready for the next sequence of image forming operations.

From a viewpoint of downsizing of the image forming apparatus, components are densely packed within the image forming apparatus. Further, as illustrated in FIG. 2, the fixing device 7 is provided immediately below the transfer device 2, and the intermediate transfer belt 15 is guided to cover the upper and right surfaces of the fixing device 7. Such a configuration enables a reduction of the height and width of the image forming apparatus.

However, when the fixing device 7 is positioned close to the intermediate transfer belt 15, the intermediate transfer belt 15 may be deformed due to heat generated by the fixing device 7 serving as a heat generator. Consequently, irregular images including color shift and so forth may occur. This problem is more prominent in high-speed image forming apparatuses within which a larger amount of heat is generated. Further, when images are formed on both sides of the sheet, the sheet heated by the fixing device 7 passes through the duplex device 5, and then the sheet contacts the intermediate transfer belt 15 again at the secondary transfer nip. Consequently, a temperature of the intermediate transfer belt 15 is further increased due to heat transmitted from the sheet. Heat is further transmitted from the intermediate transfer belt 15 to the photoconductors 18Y, 18M, 18C, and 18K each contacting the intermediate transfer belt 15, and to the developing devices 40Y, 40M, 40C, and 40K each contacting the photoconductors 18Y, 18M, 18C, or 18K. As a result, image irregularity caused by deformation of the intermediate transfer belt 15, solidification of toner, and so forth may occur more often.

The heat receiving plate 21 serving as a heat receiving member is formed of a material having good heat absorbing properties, and is provided between the fixing device 7 and a target component to be protected from heat generated by the fixing device 7, that is, the transfer device 2. The heat pipe 22 serving as heat transmission means is attached to a bottom surface of the heat receiving plate 21, and heat is received by a bottom end of the heat pipe 22 (hereinafter referred to as a heat receiving end). The other end of the heat pipe 22 serves as a heat releasing part, and is attached to the heat releasing plate 23 at a position higher than the heat receiving end. The heat releasing plate 23 serving as a heat releasing member is formed of a material having higher heat releasing performance. A heat sink may be provided on or in contact with the heat releasing plate 23 as needed.

According to illustrative embodiments, the duct 24 is extended from a front surface of the image forming apparatus to a back surface thereof, and the heat releasing plate 23 is positioned within the duct 24. An airflow entrance is provided at an end of the duct 24 on the front surface of the image forming apparatus, and an airflow exit is provided at the other end of the duct 24 on the back surface of the image forming apparatus. A discharge fan is provided at the airflow exit.

The insulation device 20 having the above-described configuration receives heat from the heat generator, that is, the fixing device 7, using the heat receiving plate 21, and the heat thus received is transmitted to the heat releasing plate 23 by the heat pipe 22. The heat is then released from the heat releasing plate 23 provided within the duct 24, and the heat thus released is discharged from the image forming apparatus by the discharge fan. Alternatively, in a case in which the discharge fan is not provided, the heat may be naturally cooled.

Thus, as described above, the image forming units 11Y, 11M, 11C, and 11K, and the transfer device 2 are effectively protected from the heat generated by the fixing device 7. As a result, the occurrence of image irregularities including color shift caused by deformation of the intermediate transfer belt 15, solidification of toner, and so forth can be effectively prevented.

In the developing devices 40Y, 40M, 40C, and 40K, when developer agitators for agitating and conveying developer stored in the developing devices 40Y, 40M, 40C, and 40K are driven, a temperature of the developing devices 40Y, 40M, 40C, and 40K is increased due to frictional heat generated by friction between the developer agitators and the developer, and friction within the developer. Further, frictional heat due to friction between the developer and developer restriction members that regulate a thickness of the developer borne on the surface of the developer bearing members to form images before the developer reaches a developing position within the image forming apparatus, and friction within the developer occurring when the thickness of the developer is restricted by the developer restriction members, increases the temperature within the developing devices 40Y, 40M, 40C, and 40K.

When the temperature within the developing devices 40Y, 40M, 40C, or 40K is increased, the charge given the toner is decreased, and therefore an amount of toner attached to the recording medium is increased. Consequently, a predetermined image density cannot be reliably obtained. Further, the increase in the temperature of the developing device 40Y, 40M, 40C, or 40K can cause the toner to melt, with the melted toner adhering to the developer restriction members, the developer bearing members, the photoconductor 18Y, 18M, 18C, or 18K, and so forth. Consequently, irregular images having undesired lines may be formed.

In particular, when recently used toner having a lower melting temperature is used in an effort to reduce fixing energy, irregular images caused by adhesion of the toner occur more often. Further, a developing device installed in a recently used image forming apparatus providing higher printing speed tends to heat up more easily.

In order to provide higher image quality and better reliability, it is important to prevent an excessive temperature increase of the developing devices 40Y, 40M, 40C, and 40K. In a related-art image forming apparatus, airflows are generated around developing devices using an air-cooling fan or the like to cool the developing devices and prevent an excessive increase in the temperature of the developing devices.

However, increasing demands for downsizing of the image forming apparatus requires a more compact duct for forming airflows around the developing devices. When the duct is downsized, the airflow around the developing devices is reduced, and consequently, the developing devices are not sufficiently cooled. To solve the above-described problems, in the image forming apparatus according to illustrative embodiments, the developing devices 40Y, 40M, 40C, and 40K are cooled using a liquid cooling device 30.

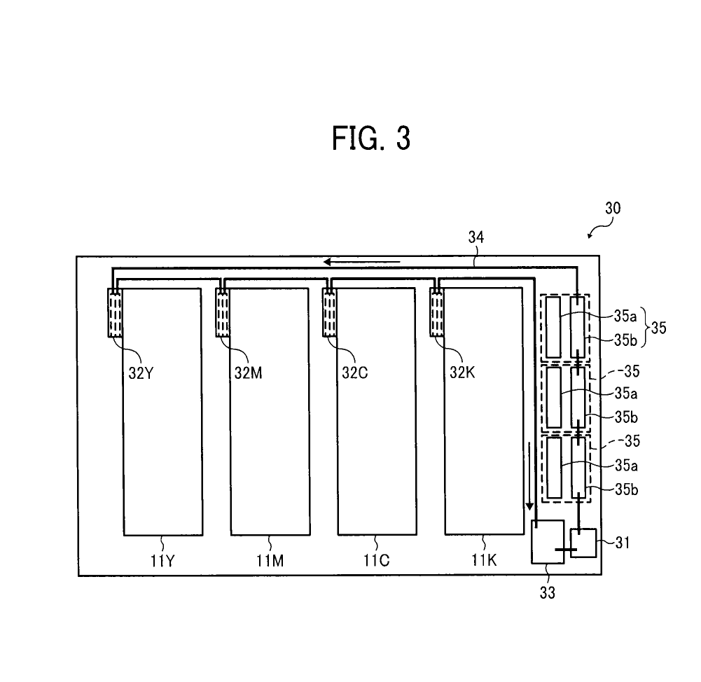

FIG. 3 is a schematic view illustrating an example of a configuration of the liquid cooling device 30. The liquid cooling device 30 is pressed against a wall surface of each of the developing devices 40Y, 40M, 40C, and 40K, that is, a portion where a temperature increase occurs. The liquid cooling device 30 includes four heat receiving parts 32Y, 32M, 32C, and 32K in which a cooling liquid inside the heat receiving parts 32Y, 32M, 32C, and 32K receives heat from the developing devices 40Y, 40M, 40C, and 40K, three cooling units 35 serving as cooling means for cooling the cooling liquid, a circulation pipe 34 that allows the cooling liquid to circulate between the heat receiving parts 32Y, 32M, 32C, and 32K and the cooling units 35, a cooling pump 31 serving as conveyance means for circulating the cooling liquid within the circulation pipe 34, a reserve tank 33 for storing an extra amount of the cooling liquid, and so forth. Each of the cooling units 35 includes a cooling fan 35a and a radiator 35b serving as heat releasing means.

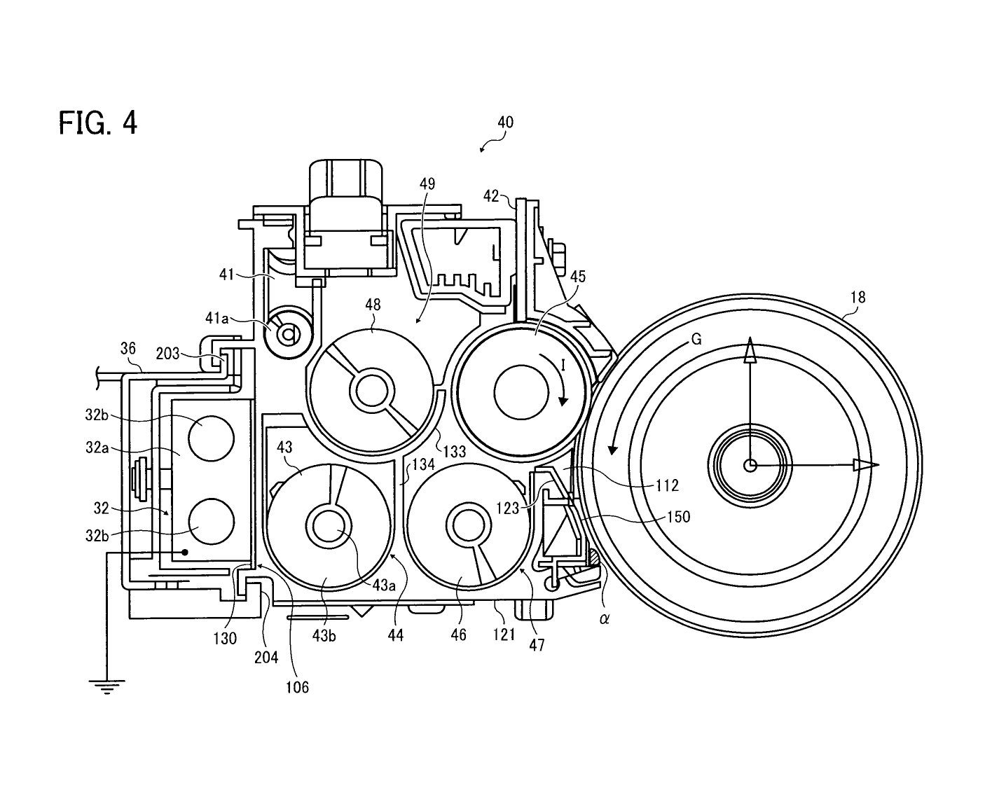

Referring to FIG. 4, the heat receiving part 32 includes a casing 32a formed of a material having higher heat conductivity, and a duct 32b formed of a material having higher heat conductivity. The duct 32b is provided within the casing 32a. Generally, the casing 32a and the duct 32b are mainly formed of copper having a heat conductivity of about 400 [W/mK], or aluminum having a heat conductivity of about 200 [W/mK]. Alternatively, the casing 32a and the duct 32b may be formed of a material having a higher heat conductivity, such as silver or gold.

Because lateral surfaces of the developing device 40 are also formed of a material having higher heat conductivity such as aluminum or copper, an airspace is formed between the developing device 40 and the heat receiving part 32 when the heat receiving part 32 is caused to contact the lateral surface of the developing device 40, reducing heat exchange efficiency.

In order to prevent a reduction of heat exchange efficiency, according to illustrative embodiments, a heat conductive sheet 130 is attached to a surface of the heat receiving part 32 facing the developing device 40 (hereinafter referred to as a contact surface) as illustrated in FIG. 4. The heat conductive sheet 130 has a high heat conductivity and flexibility to reduce profile irregularity between the developing device 40 and the heat receiving part 32. However, the heat conductive sheet 130 having higher heat conductivity tends to be hard. By contrast, the heat conductive sheet 130 having lower heat conductivity tends to be flexible. In order to provide higher heat conductivity to the heat conductive sheet 130, the heat conductive sheet 130 has a certain level of rigidity.

Therefore, the heat receiving part 32 is pressed firmly against the lateral surface of the developing device 40 to cause the heat receiving part 32 to closely contact the developing device 40. Accordingly, even the heat conductive sheet 130 having a certain level of rigidity can be deformed and a profile irregularity between the developing device 40 and the heat receiving part 32 is reduced. As a result, the appearance of an airspace formed between the developing device 40 and the heat receiving part 32 is prevented, preferably transmitting the heat from the developing device 40 to the heat receiving part 32 substantially directly. It is to be noted that, alternatively, the heat conductive sheet 130 may be attached to the lateral surface of the developing device 40.

Returning to FIG. 3, each of the cooling units 35 includes the radiator 35b serving as the heat releasing means for releasing heat from the cooling liquid via a storage. The storage is formed of a material having higher heat conductivity such as aluminum, and stores the cooling liquid conveyed from the circulation pipe 34. The radiator 35b is either cooled using the cooling fan 35a or naturally cooled without the cooling fan 35a depending on an amount of heat to be released. A number of the cooling units 35 may be one or four or more, or a number between one and four. Although the cooling fan 35a is provided to each of the cooling units 35 according to illustrative embodiments, a single cooling fan may be used to supply air to the radiators 35b of all the cooling units 35.

It is to be noted that provision of the multiple cooling units 35 preferably prevents an increase in the temperature of all the developing devices 40Y, 40M, 40C, and 40K even when the cooling efficiency of each of the cooling units 35 is low. As a result, a more compact radiator having a smaller heat releasing area and lower cooling efficiency can be used, downsizing the cooling units 35 as compared with a case in which the single cooling unit 35 is used to prevent a temperature increase of all the developing devices 40Y, 40M, 40C, and 40K.

The cooling pump 31 serves as a drive source to circulate the cooling liquid over the heat receiving parts 32Y, 32M, 32C, and 32K and the cooling units 35 in a direction as indicated by arrows in FIG. 3. The reserve tank 33 is a tank for storing the cooling liquid. The cooling liquid serves as a heat transporting medium to transport the heat received by the heat receiving parts 32Y, 32M, 32C, and 32K to the radiators 35b. The cooling liquid contains water as the main ingredient, and propylene glycol, ethylene glycol, or the like, if desired, is added in order to reduce a freezing temperature, and an antirust agent, for example, a phosphate material such as potassium phosphate and inorganic potassium chloride, may be added in order to prevent metal components from rusting, if desired.

In a case in which water is used as the cooling liquid, a larger amount of heat can be transported with a smaller amount of water because a constant volume heat capacity of water is more than 3,000 times greater than that of air. As a result, the cooling liquid can cool the developing devices 40Y, 40M, 40C, or 40K more efficiently as compared with a case in which air is used.

The surface of the photoreceptor 18 is charged by a charging device, as it rotates in the direction of the arrow G in the drawing shown in FIG. 4. Toner is supplied from the developing device 40 to a latent image, which is formed as an electrostatic latent image on the surface of the charged photoreceptor 18 by a laser beam irradiated from the exposure device 9 to form a toner image.

The developing device 40 has a developing roller 45 that serves as a developer carrier for supplying the toner to develop the latent image on the surface of the photoreceptor 18 while surface-moving in the direction of the arrow I of the drawing. The developing roller 45 has a rotatable developing sleeve 45a in which a magnetic body 45b which includes a plurality of magnetic poles, is disposed. The magnetic body retains the developer on the surface of the developing roller 45. The developer include toner and carrier.

The developing device 40 also has a supply screw 48 serving as a supply conveying member for, while supplying the developer to the developing roller 45, conveying the developer in the direction toward the far side of FIG. 4 along the axis line direction of the developing roller 45. A doctor blade 42 serving as developer regulating means for regulating the thickness of the developer supplied to the developing roller 45 to a thickness suitable for development is provided on the downstream side in the direction of surface movement of the developing roller 45 from a part where the developing roller 45 faces the supply screw 48.

A recovery conveyance path 47, which recovers the developer that passes through a developing region and is used for development after being released from the surface of the developing roller 45, faces the developing roller 45 on the downstream side in the direction of surface movement from the developing region being a part where the developing roller 45 faces the photoreceptor 18. The recovery conveyance path 47 has a spiral recovery screw 46, which is disposed in parallel with the axis line direction of the developing roller 45 and serves as a recovery conveying member for conveying the recovered recovery developer in the same direction as the direction of the supply screw 48 along the axis line direction of the developing roller 45. A supply conveyance path 49 having the supply screw 48 is disposed in the lateral direction of the developing roller 45, and the recovery conveyance path 47 having the recovery screw 46 is disposed below the developing roller 45 in parallel with the supply conveyance path 49.

Note that the developer can be separated/released from the developing roller 45 by setting a section for releasing the developer within the abovementioned magnetic body 45b of the developing sleeve into a nonmagnetic state. Moreover, the magnetic poles of the magnetic body 45b may be arranged so as to form a repulsive magnetic field in the section for releasing the developer.

A stirring conveyance path 44 is provided below the supply conveyance path 49 in the developing device 40 in parallel with the recovery conveyance path 47. The stirring conveyance path 44 has a spiral stirring screw 43, which is disposed in parallel with the axis line direction of the developing roller 45 and serves as a stirring/conveying member for, while stirring the developer along the axis line direction of the developing roller 45, conveying it in the opposite direction to the direction of the supply screw 48, the opposite direction being oriented on the near side in the drawing. The stirring screw includes a stirring shaft 43a and a spiral stirring vane 43b disposed around the stirring shaft.

The supply conveyance path 49 and the stirring conveyance path 44 are partitioned by a first partition wall 133 serving as a partition member. In a part of the first partition wall 133 that partitions the supply conveyance path 49 and the stirring conveyance path 44, there is an opening portion at both ends in the near side and far side of the drawing to thereby allow the supply conveyance path 49 and the stirring conveyance path 44 to communicate with each other.

Note that although the supply conveyance path 49 and the recovery conveyance path 47 are also partitioned by the first partition wall 133, there is no opening portion provided in the part of the first partition wall 133 that partitions the supply conveyance path 49 and the recovery conveyance path 47.

The two developer conveyance paths of the stirring conveyance path 44 and the recovery conveyance path 47 are also partitioned by a second partition wall 134 serving as a partition member. An opening portion is formed in the second partition wall 134 at the near side in the drawing to allow the stirring conveyance path 44 and the recovery conveyance path 47 to communicate with each other.

The supply screw 48, the recovery screw 46 and the stirring screw 43 serving as a developer conveying members are made of resin or metal. The diameter of each screw is set to 22 mm, for example. The supply screw is in the form of a double-thread screw and has a screw pitch of 50 mm, for example, and the recovery screw 6 and the stirring screw 11 each is in the form of a single-thread screw and has a screw pitch of 25 mm, for example. The rotation speed of each screw is set to approximately 600 rpm. In this embodiment, a length of the stirring path 44 is 410 mm, for example, and a length of the supply conveyance path 49 is 320 mm, for example.

The developer that is thinned by the stainless doctor blade 42 on the developing roller 45 is conveyed to the developing region where the developing roller 45 faces the photoreceptor 18, and then development is performed. The surface of the developing roller 45 made of an Al or SUS pipe stock with a diameter of 25 mm, for example has grooves like a V-shaped groove, depressions, is sprayed, or is sandblasted by recessing. The size of the gap formed between the doctor blade 42 and the photoreceptor 18 is approximately 0.3 mm.

The developer obtained after the development is recovered by the recovery conveyance path 47, conveyed to the near side of the cross section of FIG. 4, and then transferred to the stirring conveyance path 44 at the opening portion of the first partition wall 133 provided in a non-image region. It should be noted that toner is supplied from an after-mentioned toner replenishing port 201 to the stirring conveyance path 44, the toner replenishing port 201 being provided above the stirring conveyance path 44 and in the vicinity of the opening portion of the first partition wall 133 on the upstream side in a developer conveyance direction in the stirring conveyance path 44.

A casing 121 of the developing device 40 includes walls of the stirring path 44, the recovery conveyance path 47, and the supply conveyance path 49.

FIG. 7 shows a flow of the developer of the lower part of the developer 40. An arrow I describe a flow of the developer when the developer used on the developing roller 45 is conveyed by the recovery screw and the stirring screw 43 and pushed to upper part of the developing device. A dashed line “a” area is a part where the developer is conveyed to upper part. A dashed line “b” area is a part where the developer is conveyed to parallel.

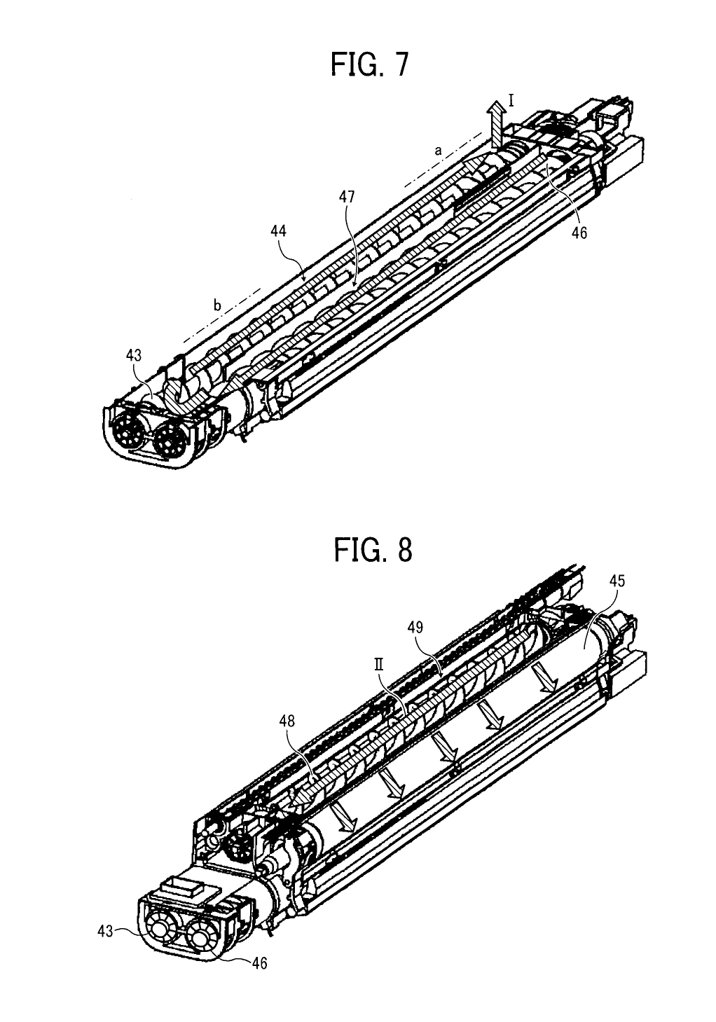

FIG. 8 shows a flow of the developer of the upper part of the developing device 40. An arrow II shows a flow of the developer when the developer pushed by the stirring screw 43 is conveyed to the developing roller by the supply screw 48.

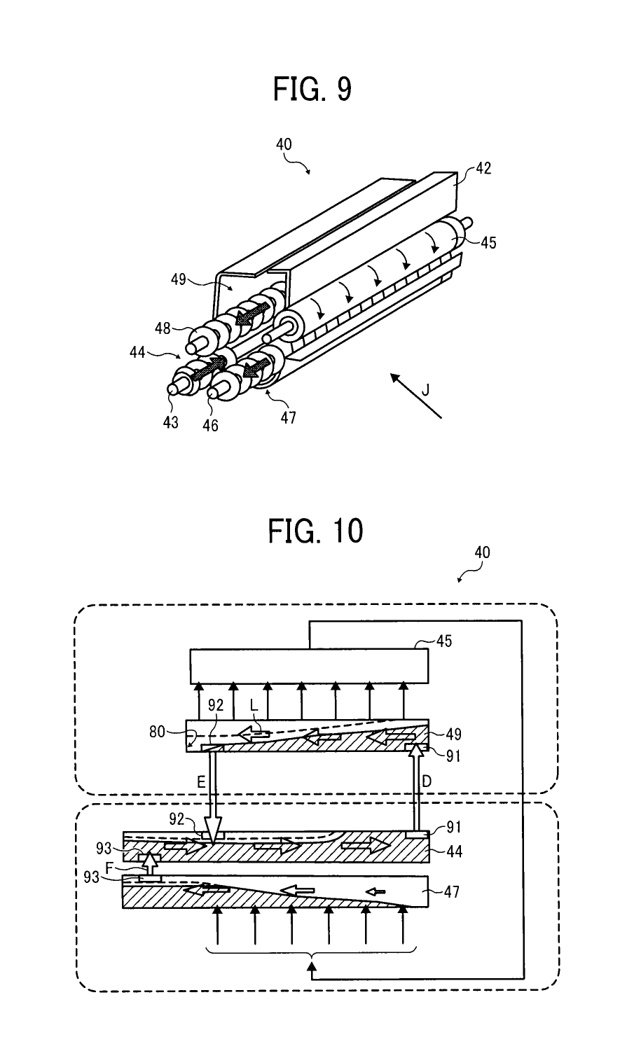

Next, the circulation of the developer within the three developer conveyance paths will be described. FIG. 9 shows a perspective sectional view of the developing device 40 to explain a flow of the developer within the developer conveyance paths. The arrows in the drawing indicate the directions of movement of the developer. Also, FIG. 10 is a schematic diagram showing a flow of the developer within the developing device 40. As with FIG. 9, the arrows in the diagram indicate the directions of movement of the developer.

In the supply conveyance path 49 to which the developer is supplied from the stirring conveyance path 44, the developer is conveyed to the downstream side in a conveyance direction of the supply screw 48, while being supplied to the developing roller 45. Excess developer that is supplied to the developing roller 45 and conveyed to a downstream end in a conveyance direction of the supply conveyance path 49 without being used for the development is supplied to the stirring conveyance path 44 through an excess opening portion 92 of the first partition wall 133 (arrow E in FIG. 10).

On the other hand, the developer supplied to the developing roller 45 is used for the development in the developing region, separated/released from the developing roller 45, and delivered to the recovery conveyance path 47. The recovery developer that is delivered from the developing roller 45 to the recovery conveyance path 47 and conveyed to a downstream end in a conveyance direction of the recovery conveyance path 47 by the recovery screw 46 is supplied to the stirring conveyance path 44 through a recovery opening portion 93 of the second partition wall 134 (arrow F in FIG. 10).

The stirring conveyance path 44 then stirs the supplied excess developer and recovery developer, conveys thus obtained mixture to the upstream side in the conveyance direction of the supply screw 48, which is also the downstream side in a conveyance direction of the stirring screw 43, and supplies it to the supply conveyance path 49 through a supply opening portion 91 of the first partition wall 133 (arrow D in FIG. 10).

In the stirring conveyance path 44, the recovery developer, excess developer, and toner replenished from a transporting portion according to need are stirred and conveyed by the stirring screw 43 in the direction opposite to that of the developer of the recovery path 47 and the supply path 49. The stirred developer is transported to the upstream side in the conveyance direction of the supply conveyance path 49 that is communicated at the downstream side in the conveyance direction through the supply opening portion 91.

In the developing device 40 shown in FIG. 10 having the supply conveyance path 49 and the recovery conveyance path 47, because the developer is supplied and recovered in different developer conveyance paths, the developer used for the development is prevented from being mixed in the supply conveyance path 49. Accordingly, the toner density of the developer supplied to the developing roller 45 is prevented from decreasing as the developer is sent toward the downstream side in the conveyance direction of the supply conveyance path 49.

In addition, because the developing device has the recovery conveyance path 47 and the stirring conveyance path 44 and the developer is recovered and stirred in these different developer conveyance paths, loss of the developer used for the development is prevented while it is being stirred. Therefore, since the sufficiently stirred developer is supplied to the supply conveyance path 49, supply of insufficiently stirred developer to the supply conveyance path 49 can be prevented. Because the toner density of the developer within the supply conveyance path 49 is prevented from decreasing and insufficient stirring of the developer in the supply conveyance path 49 is prevented in this manner, a constant image density can be ensured throughout development.

As shown in FIG. 10, the developer is moved from the lower part of the developing device 40 to the upper part of the same in the direction of the arrow D only. The developer is moved in the direction of the arrow D to raise the developer and supply it to the supply conveyance path 49 by pushing the developer existing on the downstream side of the stirring conveyance path 44 as the stirring screw 43 rotates.

It should be noted that a fin member may be provided on the axis of the stirring screw 43, which is a section through which the stirring conveyance path 44 and the supply conveyance path 49 are communicated with each other at the downstream side of the developer conveyance path of the stirring conveyance path 44. This fin member is a plate-like member with a side parallel to the axial direction of the stirring screw 43 and a side perpendicular to the axial direction of the stirring screw 43. By scooping up the developer using this fin member, the developer can be delivered from the stirring conveyance path 44 to the supply conveyance path 49 efficiently.

Also, the stirring screw 43 rotates in the counterclockwise direction as viewed from the near side of FIG. 4 (direction of the arrow G in the drawing) so that the developer is lifted up along the shape of the stirring screw 43 and transported to the supply conveyance path 49. Accordingly, the developer can be lifted up efficiently and also the stress placed thereon can be reduced.

A developer discharge opening is disposed at the downstream end of the supply conveyance path and connecting the supply conveyance path 49 and a discharging path. The developer that has reached a height of the developer discharge opening is discharged from the supply conveyance path 49 to the discharging path. The developer discharged to the discharge path is conveyed to a developer collecting part disposed out of the developing device 40 by a discharge screw 41a.

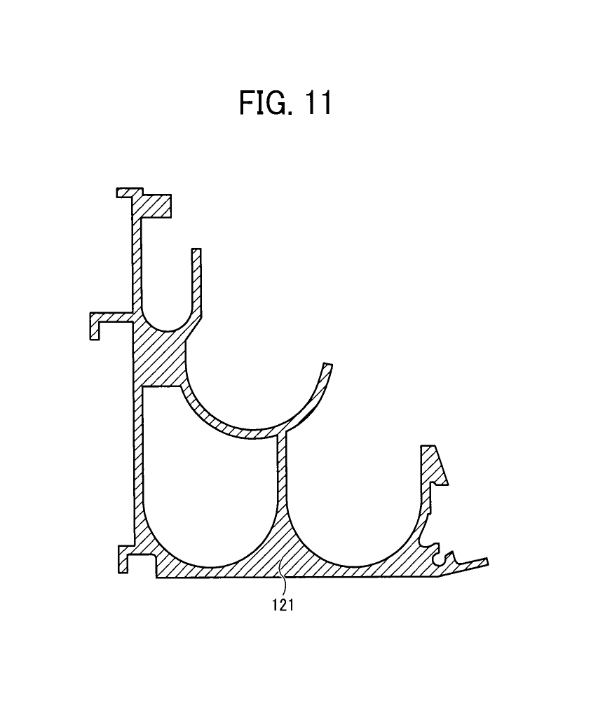

FIG. 11 is a view of a cross section of the casing 121 including three paths as developer storing part.

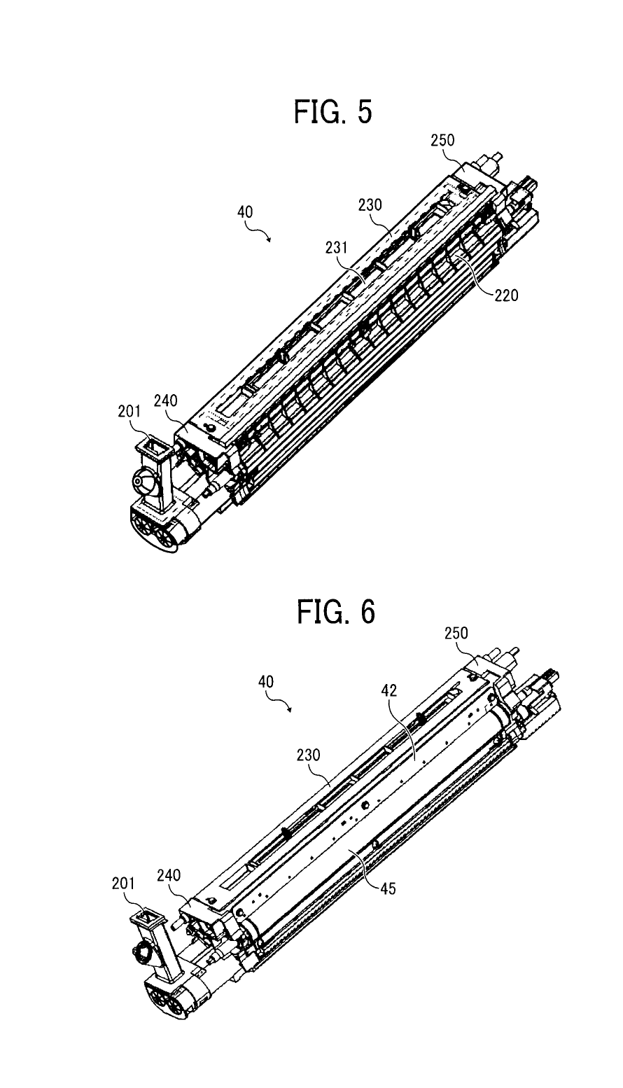

As shown FIG. 4, FIG. 5, and FIG. 6, the developing device forms a developer housing storing developer including the casing 121, upper path cover 230, upper developing roller cover 220, rear side plate 250, and near side plate 240. The housing of the developing device 40 has a longitudinal (axis direction) length that is longer than a width of a printed area of a printing medium like paper.

As shown in FIG. 5 and FIG. 6, the rear side plate 250 and near side plate (front side plate) 240 included as part of the housing are supporting members supporting both ends of the axis direction of the casing 121, developing roller 45, and three rotating shafts of the conveyance screws. The upper path cover 230 fixed to cover the upper side of the casing 121, and forming the supply conveyance path, and fixing the doctor blade 42. The upper developing roller cover 220 is a member covering a surface of the developing roller 45 of an area where a side of the developing area other than the doctor blade 42. When the developing device is for A3 size paper, the length of the casing is greater than 297 mm.

The casing 121 has identical cross-sectional forms in the axis direction, and a certain length in the axis direction. Furthermore, the stirring conveyance path is cylindrical shaped and enclosed by the wall to store the developer. The developing device in this embodiment is formed by extrusion molding of aluminum. It is possible to make the case of other materials, although aluminum is a preferable material. The casing 121 can be formed to have an identical cross-section in the axis direction, and a certain length in the axis direction by extrusion molding. Since the casing 121 is preferably made of metal such as an aluminum, it is connected to the image forming apparatus via a ground terminal, thus preventing the problem of charging of the casing 121.

Since the casing 121 is preferably made of metal like aluminum, the heat of the developer transfers to the heat receiver 32 of cooling device 30 via casing 121.

When the developing sleeve 45a of the developing roller 45 is rotating, a part of the developer on the developing sleeve 45a may be scattered by centrifugal force.

When an amount of the scattered developer is increased, the scattered developer is stored at around a region a shown in FIG. 4. This stored developer may fall down to images, and cause abnormal images.

In this embodiment, a duct 150 is disposed at a downstream side of the developing sleeve rotation. As shown in FIG. 1, the scattered developer is suctioned to a suction opening 150a disposed at the duct 150 by air which is sucked in by a pump. The developer which is suctioned is stored in a developer collecting container.

To make an air flow to the inner part of the developing device at the downstream of rotating direction of the developing sleeve 45a and the part where the developer passes through the developing area is collected, is effective to prevent the developer from falling out of the developing device. The air flow carries the developer which falls from the developing sleeve 45a to the inside of the developing device via a gap between the developing roller 45 and casing 121.

Since the airflow occurs, the developer released from developing roller 45 is collected at the inner side of the developing device 40. To optimize the airflow, the casing gap area between a part of casing 121 where a surface of the developing sleeve 45a passed developing area enters the inner side of casing 121, and developing roller 45, is designed to be optimal. The air flow toward the inner side of the developing device 40 (pumping air flow) occurs by a magnetic brash conveyed by developing roller 45. However, when a gap between the developing brush and the casing 121 is too wide, the pumping air flow does not occur in the whole area of the casing gap area, and the effect to prevent a scattering of the developer is not enough.

The developing brush carried by the developing roller 45 causes the air flow in the same direction of the developer moving direction. However the air flow causes the increasing of pressure of inner side of the developing device 40. Moreover, air of the inner side of the developing device passes through a gap between the casing and edge of the magnetic brush. It is desirable that the magnetic brush contacts the casing 121 to prevent the scattering of developer by the air flow. On the other hand, if the casing gap area is too narrow, the developer carried by the developing roller 45 cannot pass through the casing gap area to the inside of the developing device 40.

The casing gap area is preferably designed so that the developer carried by developing roller 45 can pass through the gap and the magnetic brush can contact the gap. According to experiments, when the casing gap is 0.7-0.8 mm, the scattering of developer is reduced the most.

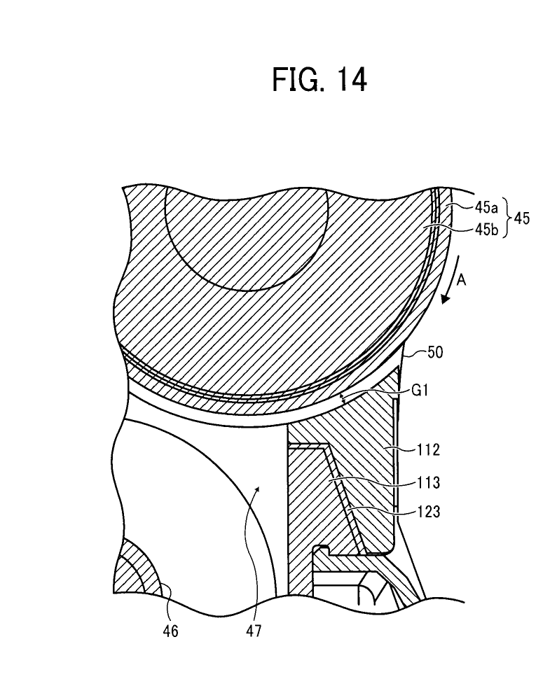

The developing device has a gap adjusting member (shown as 112 in FIG. 14) adjusting the width of the gap between the developing sleeve 45a and casing 121 at the part of casing 121 where a surface of the developing sleeve 45a passed developing area enters the inner side of casing 121. The gap adjusting member is separated from the casing and a position where the gap adjusting member is fixed to the casing can be adjusted.

Since a position where the gap adjusting member is fixed to the casing can be adjusted, the width of the casing gap can be adjusted. The adjusting member may be exchanged for another adjusting member that has a different shape and the casing gap may be adjusted by this exchanging.

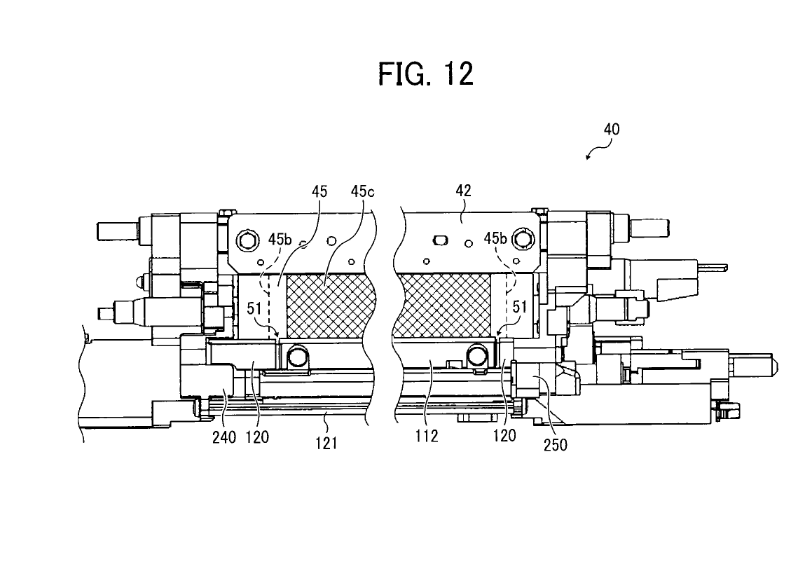

FIG. 12 is side view of the developing device without upper developing roller cover 220. The cross-hatching area of the surface of the developing roller 45 of FIG. 12 is a developer carrying region 45c to carry the developer with convex surface. Broken-lines at both ends of the developing roller outside the developer carrying region 45c shows both ends of the magnetic body 45b disposed in the developing sleeve 45a in the axis direction.

When the casing 121 and the gap adjusting member are separated, there is a gap. In FIG. 12, a border part 51 between the gap adjusting member and a gap adjustment axial edge 120 at the casing of opposite side of the gap adjusting member is disposed outside of the end of the developer carrying region 45c in the axis direction. Moreover, the border part 51 is disposed at the inner side of axial direction of a magnetization region where the developer is attracted to the developing roller by the magnetic force of the magnetic body 45b.

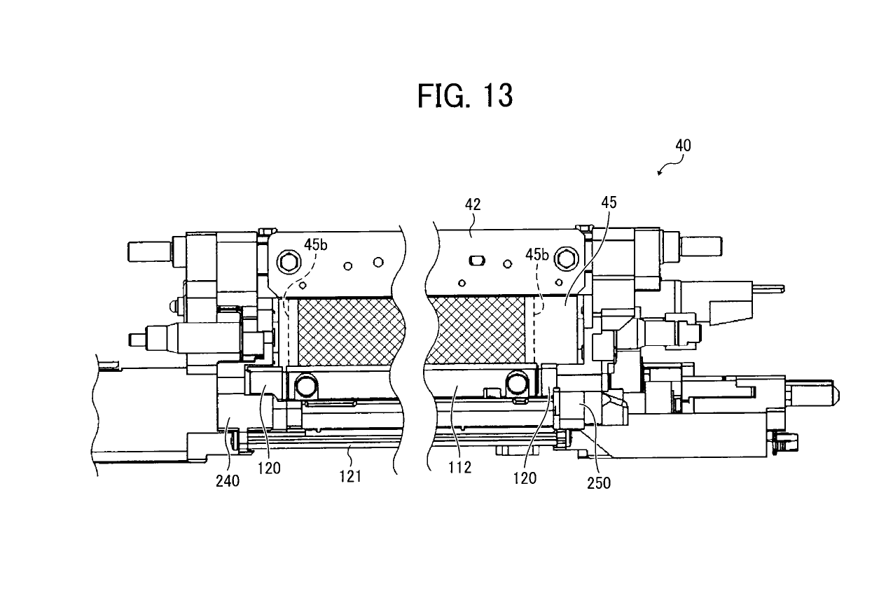

FIG. 13 is side view of the developing device in which the border part is different from the above embodiment of the developing device 40. This is a reference view. The border part 51 of the developing device of reference is disposed at the outer side of the axial direction of a magnetization region. Other components are same as the above embodiment.

FIG. 14 is an enlarged cross sectional view of the casing gap area of the developing device described in FIG. 4. The gap adjusting member 112 is separated from the casing 121, and is fixed to a gap adjusting member fixing part 113.

As shown FIG. 14, a surface of the gap adjusting member 112 opposed to the developing roller 45 is curved surface along the surface of the developing roller 45. At the near portion of the casing gap, the surface of the developing sleeve moves from the outer side of the casing 121 to the inner side of the casing 121, as shown arrow A described in FIG. 14.

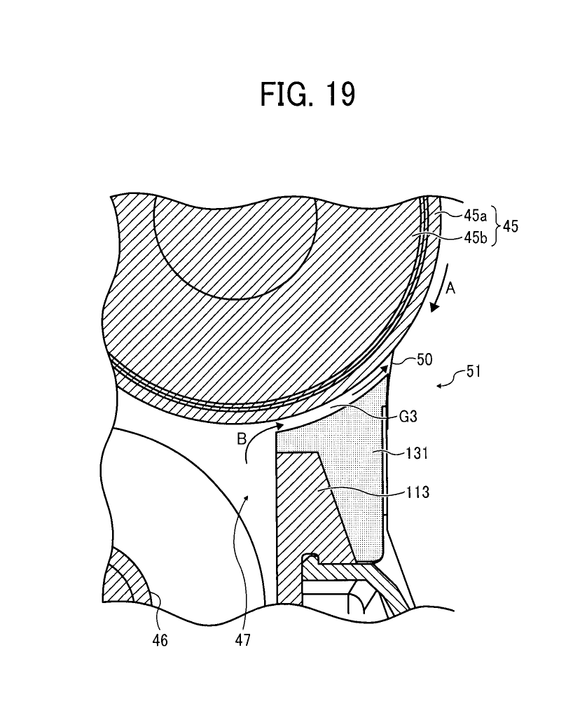

The gap adjusting member 112 can move toward a center of the developing roller along a slope of the gap adjusting member fixing part 113. The gap adjusting member 112 and the gap adjusting member fixing part 113 is fixed at three portion in the axis direction by the screws, after the gap between the gap adjusting member 112 and the developing roller 45 is adjusted to an appropriate gap G1. When the gap adjusting member 112 is fixed to the gap adjusting member fixing part 113, a sponge seal 131 shown in FIG. 19 is sandwiched to prevent a space at the border or end of the gap adjusting member 112.

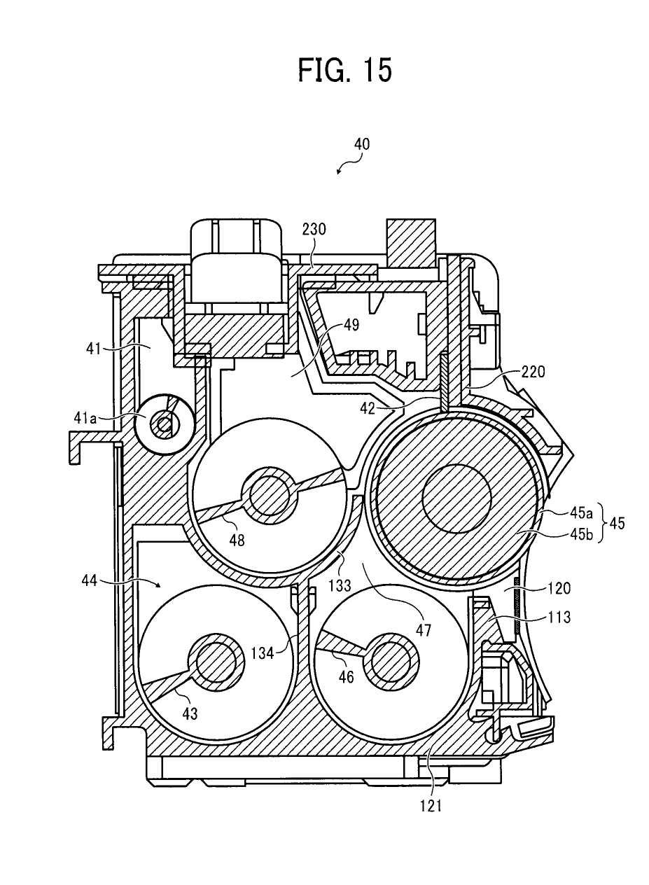

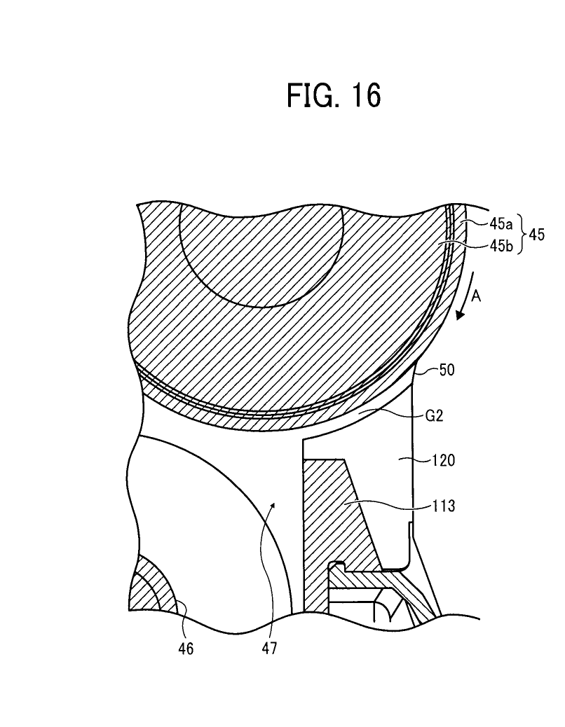

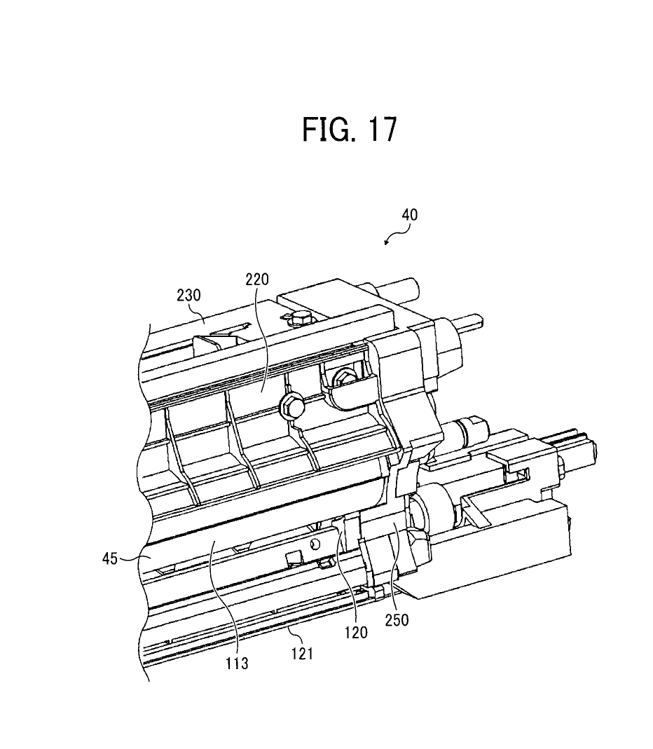

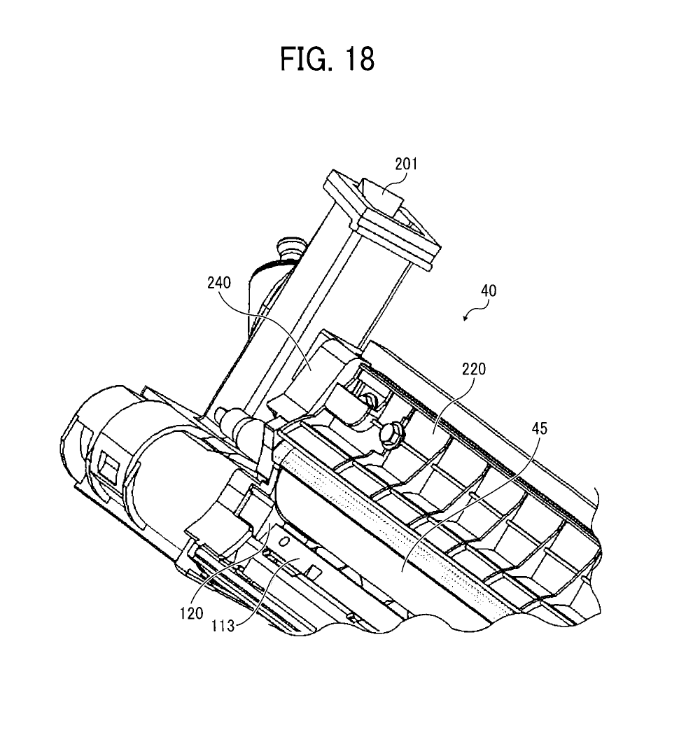

FIG. 15 is a cross section view of the developing device without the gap adjusting member 112 and sponge seal 131. FIG. 16 is an enlarged cross-section view of the casing gap of the developing device 40 of FIG. 15. FIG. 17 is an enlarged perspective view of the developing device without the gap adjusting member 112 and sponge seal 131. FIG. 18 is an enlarged perspective view of a near side of the developing device 40.

FIG. 19 is an enlarged cross section view of the casing gap near the border 51 of the developing device 40 of a reference example. When the sponge seal 131 as an insulation member and the gap adjusting member 112 are attached, a gap between the outer surface of the axial direction of the gap adjusting member 112 and inner surface of the axial direction of the gap adjustment axial edge 120 shown in the FIG. 15 to FIG. 18, is formed at the border 51.

Since the gap is connected to the recovery conveyance path as a developer storing part, the developer in the recovery conveyance path may be leaked to outside of the developing device 40. To prevent the leaking, the elastic sponge seal 131 is disposed at the border 51 as shown FIG. 19.

Since the gap adjusting member 112 can move relative to the casing 121, a shape of the gap at the border 51 is changed by a position of the gap adjusting member 112. However the sponge seal can change the shape so that the sponge seal 131 covers the gap.

However as shown in FIG. 19, a border gap G3 is formed between the sponge seal 131 and the developing roller at the border 51. The border 51 of the developing device of reference example shown in FIG. 13 is disposed at outside of the magnetization region. Therefore, the developer is not carried by the developing roller 45 surface facing the border gap G3, and the gap is maintained.

When the developing device is driven in the above situation, the pressure is increased by the pumping air flow which occurs by the developer at the developer carried region. Then an air flow passing through the border gap G3 toward the outside as shown arrow B in the FIG. 19 occurs. The developer in the recovery conveyance path is pushed by the air flow, and is leaked from the developing device 40.

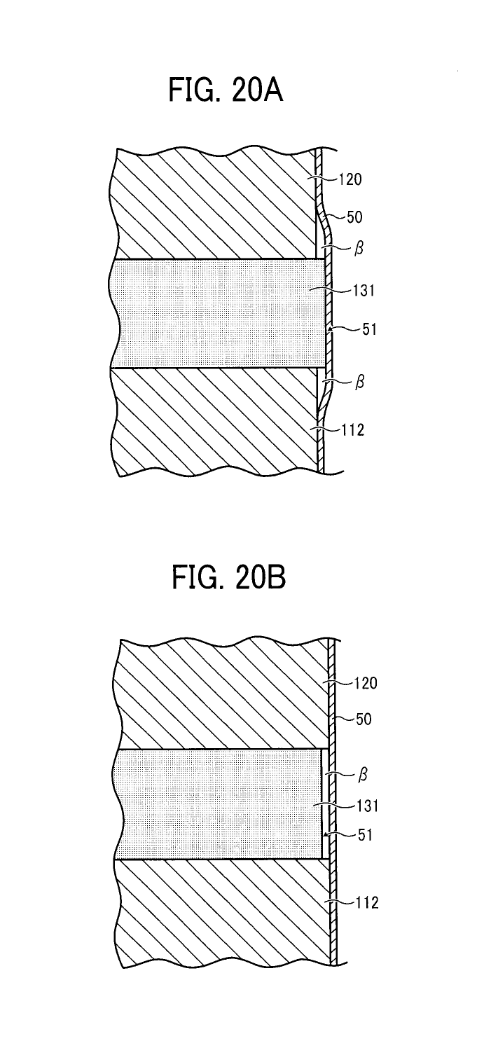

FIGS. 20A and 20B are enlarged cross-section view of the border 51 with an entrance seal 50 between the gap adjusting member 112 and the gap adjustment axial edge 120. The gap adjusting member 112, the gap adjustment axial edge 120, and the sponge seal 131 are separated. A step occurs by a combination of peripheral members at the border 50. FIG. 20A is a view of a situation in which the sponge seal 131 is protruding outwardly from the other members and a step exists. FIG. 20B is a view of a situation in which the sponge seal 131 is retracted from the other members at the inner side.

As shown in FIG. 20A, since the step exists, a gap β occurs between the three members which is the gap adjusting member 112, the gap adjustment axial edge 120, and the sponge seal 131. With the existence of a gap, the developer which passed through the border gap G3 of FIG. 19, reaches the entrance seal 50 leaks to the outside of the developing device 40 through the gap β.

In the developing device 40 of present invention, the gap adjusting member 112 and two borders 51 are preferably aligned in an axial direction for the width of the magnetization region.

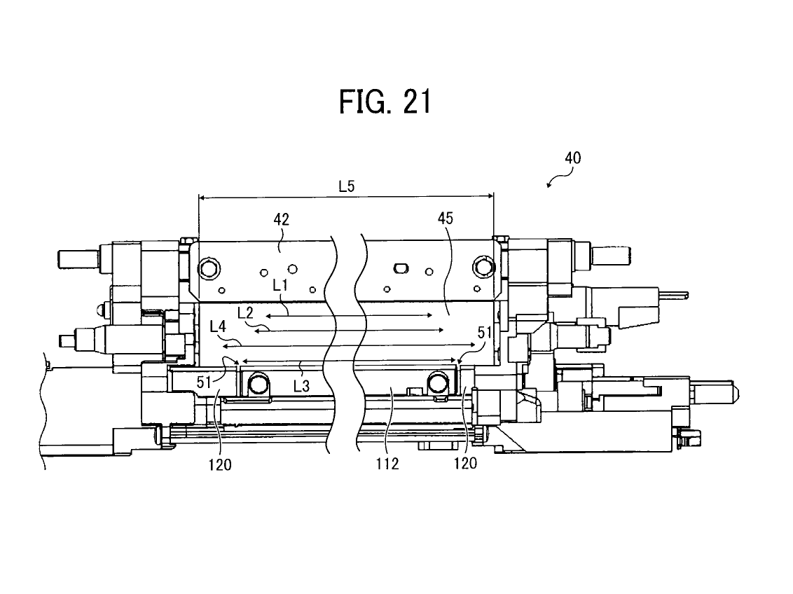

FIG. 21 is a schematic view of lengths of the parts of the developing device 40 of the present invention. As shown in FIG. 21, the width of the printed area L1 that is a minimum length of the lengths is decided based on a maximum width of the printed medium. The reason for the maximum width is that to supply the developer with uniform consistency to the whole area of the width of printed area L1 is needed to develop the electrostatic latent image on the photoreceptor correctly.

The surface of the developing sleeve 45a has recesses, such as V-shaped grooves, depressions, is sprayed, or is sandblasted to achieve the recesses.

To supply the developer to the whole area of the width of the printed area L1, a width of the recessed area L2 is longer than the width of printed area L1 in a longitudinal direction of the developer carried region 45c, which is illustrated in FIGS. 12 and 13. Both end sides of the longitudinal direction of the width of recessed area L2 are disposed wider than both end sides of the width of printed area L1.

A width of a magnetization area L4 which is the longitudinal length of the magnetization area, is longer than the width of recessed area L2. And preferably, both ends of the longitudinal direction of the magnetization area are disposed wider than the developer carried region 45c.

In this embodiment, a width of the gap adjusting member L3 of the longitudinal direction of the gap adjusting member 112 is wider than the width of recessed area L2, and narrower than the width L4 of magnetization region. The border 51 formed at both ends of longitudinal direction of the gap adjusting member 112 is outside of longitudinal direction of the developer carried region 45c, and is inside of longitudinal direction of the magnetization region. Therefore the casing gap G1 illustrated in FIG. 14 is optimized by the gap adjusting member 112 is guaranteed at the area of the developer carried region 45c where the developer is carried.

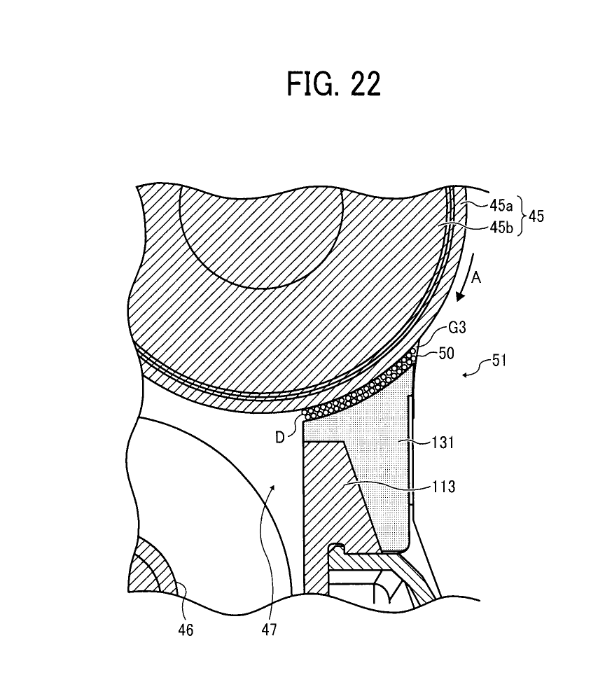

Furthermore, the developing device 40 in this embodiment, as shown in FIG. 12, has a border 51 at inner side of both ends of the longitudinal direction of the magnetization region. FIG. 22 is an enlarged cross-section view of the casing gap near the border of the developing device 40 of this embodiment.

Since the border 51 is at the outer side of the longitudinal direction of the developer carried region 45c, the developer is not carried positively by the surface of the developing roller 45 opposed to the border 51. However, since the border 51 is at the inner side of the longitudinal direction of both ends of the magnetization region, the developer presence at the border gap G3 which is the gap between the sponge seal 131 and the developing roller 45 is affected by a magnetic force of the magnetic body.

The developer D which reaches the border gap G3 is attracted to the developing roller 45 and is kept on the surface of the developing roller 45, as shown in FIG. 22. The developer D kept on the developing roller 45 fills up the border gap G3, and developer leaks from the border gap G3 are prevented.

Since the border 51 is disposed at the outer side of the longitudinal direction of the developer carried region 45c, almost no developer is kept on the surface of the developing sleeve 45a passed through the region where the developing roller 45 opposed to the photoreceptor 18 and reached to the border gap G3. So, when the surface of the developing sleeve 45a opposed to the border 51 is exposed to the outside of the casing 121, the developer is not scattered by a centrifugal force.

In developing device 40 of this embodiment, the rear side plate 250 and near side plate 240 are made of resin. The casing 121 and the gap adjusting member 112 are made of aluminum. The width of the casing gap G1 to prevent scattering of the developer and to keep the circulation flow of the developer is 0.7-0.8 mm. In this embodiment, an appropriate casing gap G1 which is to adjust and assemble the gap adjusting member 112 to the developing device 40 is achieved.

As shown in FIG. 12, the end of the magnetization region is opposed to the gap adjustment axial edge 120. As shown FIG. 16, a gap (end gap G2) is formed between the gap adjustment axial edge 120 and the developing roller 45.

The developer in the developing device may leak from the end gap G2. However, as the end gap G2 is outside of the developer carried region 45c, it is not necessary to consider the pumping air flow to prevent the developer scattering and to make the developer pass. The gap adjustment axial edge 120 forming the end gap G2 is different from the sponge seal 131 and a part of the casing 121 so that the shape is fixed. Therefore, the setting which brings the gap adjustment axial edge 120 close to the degree which does not touch the developing roller 45 and narrows edge gap G2 is possible.

In a region of the end gap G2 where the end gap G2 opposes the magnetization area, the developer kept on the developing roller 45 fills the end gap G2. Thus, leaking of developer from the end gap G2 is prevented.

On the other hand, the developer in the developing device 40 may pass through the end gap G2 and reach an outer opening of the end gap G2 in the region of the end gap G2 where the end gap G2 opposes to an outer area of the magnetization region in the axis direction. The developer reaching to the outer opening of the end gap G2 is prevented from leaking by the entrance seal 50 attached surface of the gap adjusting member 112 and the gap adjustment axial edge 120 opposed to the photoreceptor 18 so that the entrance seal covers the border 50.

In a region where the entrance seal is attached to only the gap adjustment axial edge 120, a gap does not occur, thus preventing a developer leak. The developer which reaches the entrance seal 50 moves along the axis direction to the entrance seal 50 and gap adjustment axial edge 120, and may move to a gap which occurs by a step described as β in FIG. 20.

However, an area where the gap occurs by step near the border 51 is included in the magnetization region. The developer which passes through the gap between the gap adjustment axial edge 120 and the developing roller 45 is held by the magnetic force of the developing roller 45. Therefore the developer which reaches the outer opening of the end gap G2 is prevented from reaching the gap of the surface to which the entrance seal is attached which has occurred by the step. Thus, the developer is prevented from leaking from the end gap G2.

As shown in FIG. 21, a length L3/2 from the center of printed area, which is equal to the center of the recessed area of the developing sleeve 45a in this embodiment, to an end of the longitudinal direction of the gap adjusting member 112 is 170 mm. The gap adjustment axial edge 120 and the end of the longitudinal direction of the gap adjusting member 112 sandwich a 1 mm gap (border 51).

A length L2/2 from the center of the printed area to an end of the longitudinal direction of the developer carried region is 167 mm. A length L4/2 from the center of the printed area to an end of the longitudinal direction of the magnetization region is 175 mm. And a length L5/2 from the center of the printed area to an end of the longitudinal direction of the developing roller is 185 mm.

As shown in above embodiment, the entire border 51 as a gap between the gap adjustment axial edge 120 that is a part of the casing 121 and the gap adjusting member 112 is in the magnetization region. Therefore, the developer around the border 51 is kept by the magnetic force of the developing roller, and the leaking of the developer from the border 51 is prevented.

In this embodiment, the developer in the recovery conveyance path 47 is conveyed to a left side in the FIG. 12, and a right side in the FIG. 12 is an upstream of the conveyance direction of the developer. Applying a constitution that the border 51 is inside of the magnetization region to end of an upstream portion is more effective than applying to a downstream portion.

In the recovery conveyance path, since the developer that has passed through the developing area is recovered, the developer height level becomes higher as it approaches the downstream. In the downstream side, if a part of developer flies temporary, the developer is caught by a developer stream. So, the developer in the downstream side is not so much influenced by the air flow which occurs in the recovery conveyance path 47.

On the other hand, upstream of the recovery conveyance path, if a part of the developer flies temporary, the flying developer is influenced by the air flow which occurs in the recovery conveyance path. When the flying developer is caught by the air flow which is moving toward an outside as shown by arrow B in FIG. 19, the developer leaks to the outside. So, having the border 51 inside of the magnetization region at an upstream side where the flying developer is difficult to be caught by the stream of the developer is more effective than having the border at a downstream side. Therefore, when the only border 51 in one end of the ends of the gap adjusting member 112 is needed to be inside the magnetization region, it is desirable that the border 51 of the upstream side of the developing movement direction be inside the magnetization region.

Regarding the entrance seal 50 a filler is able to fill to a gap formed by the gap adjusting member 112, the casing 121, the sponge 131, and the entrance seal 50. When the filler fills the gap, there is not a gap to leak the developer which reaches to the entrance seal 50 so the developer is prevent from leaking.

However, using filling the filler to the gap formed by the gap adjusting member 112, the casing 121, the sponge 131, and the entrance seal 50 takes cost and time. On the other hand, in this embodiment, the developer is prevented from leaking without using filler to fill the gap.

As shown in FIG. 4, a holder 36 holding the heat receiving part 32 using a pushing a pushing force against the developing device is attached to a left side surface of the developing device 40 by a first hook 203 and second hook 204. The heat receiving part 32 is held to contact a contacting surface 106 disposed at an outer surface of the casing 121 of the developing device. A location of the contacting surface 106 in the longitudinal direction of the casing 121 is a region of a dot-line in FIG. 7, and a near end of downstream side of the stirring conveyance path 44.

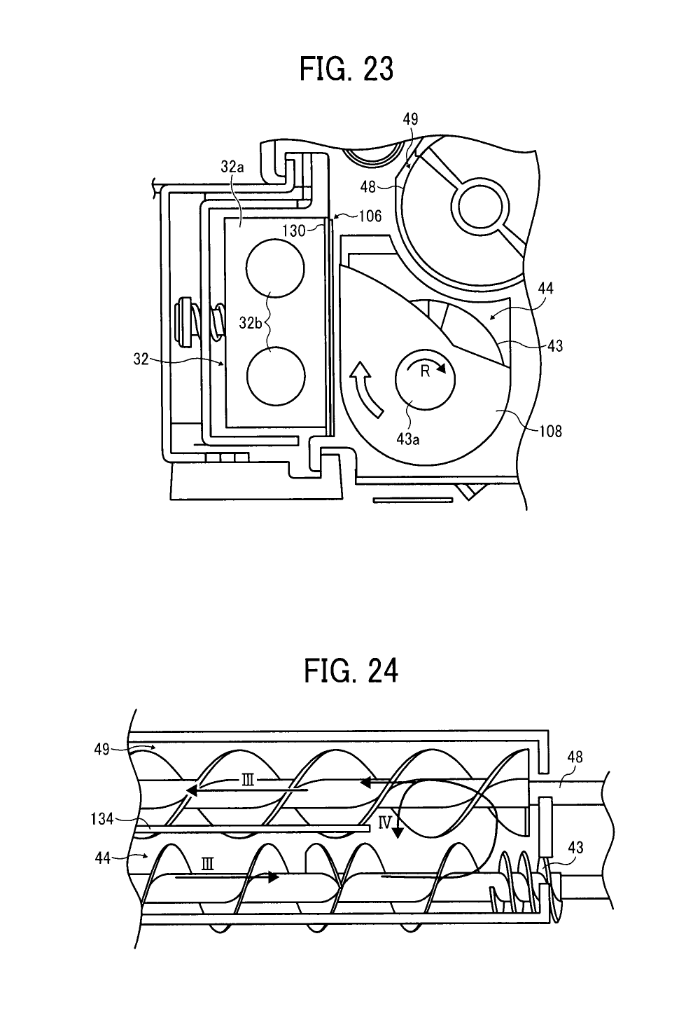

FIG. 23 is a view of a deviation of the developer 108 in the stirring conveyance path 44. The stirring screw 43 is rotated clockwise as shown by the arrow R. The developer is collected at a part where the developer contacts a wall near the contacting surface cooled by the heat receiving part 32. In this way, when the developer is collected at the part where the developer contacts a wall near the contacting surface cooled by the heat receiving part 32 by the stirring screw 43, the developer is cooled by the heat receiving part 32 via the wall easily, and a cooling efficiency is improved.

As shown in FIG. 7, there is a portion where the developer is conveyed upwardly toward the supply conveyance path 49 in an end part of the downstream portion of the developer conveyance direction. In this portion, the developer is retained at the end part of the downstream of the developer conveyance direction, and is collected more than the recovery conveyance path 47 and the supply conveyance path 49. Therefore in this embodiment, the developer is cooled by the heat receiving part 32 via the wall easily, and a cooling efficiency is improved.

FIG. 24 is a view of the developer flow at the portion where the developer is conveyed from the stirring conveyance path 44 upwardly toward the supply conveyance path 49. Arrows III illustrate a flow of the developer from the stirring conveyance path 44 to the supply conveyance path 49.

In this portion, since the developer is conveyed upwardly, a part of the developer is returned from a side of the supply conveyance path to the stirring conveyance path by gravity. This flow is shown as an arrow IV. The developer is stirred in the portion and cooled uniformly.

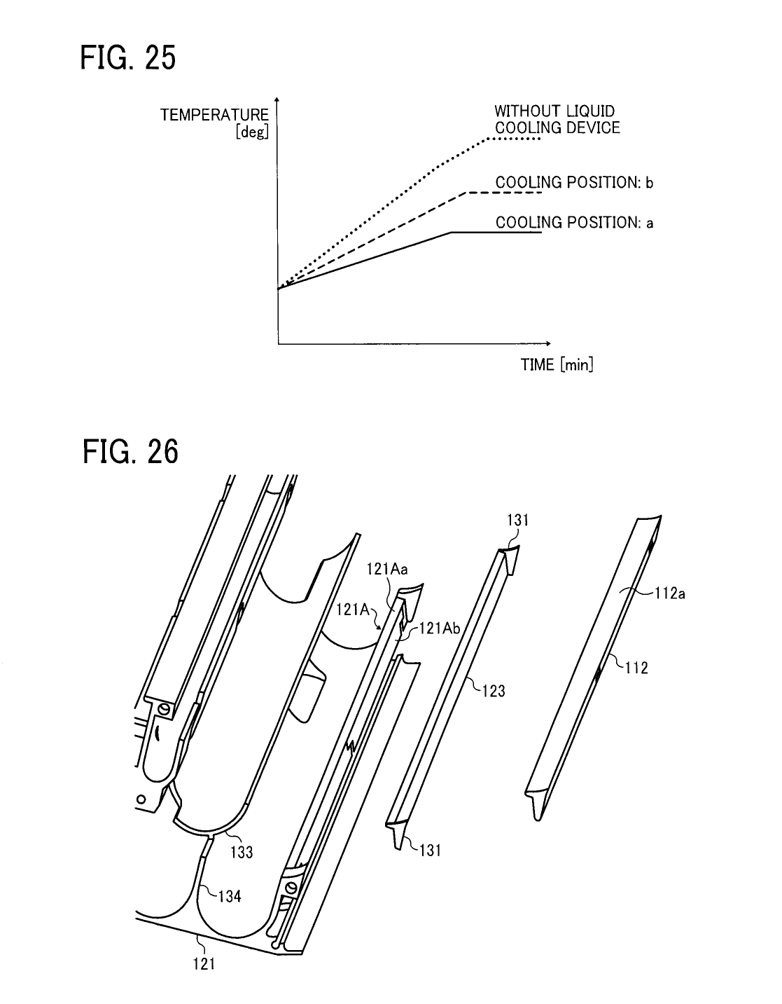

FIG. 25 is a graph of a relation between a passed time of the developing device 40 and variation of a temperature. The lines of the graph respectively show ‘without liquid cooling device’, ‘cooling position b’, ‘cooling position a’ in turn from the top. A line of ‘cooling position a’ illustrates a case in which an outer wall of the casing 121 where the developer is conveyed upwardly (the region enclosed a dashed line a in FIG. 7) contacts to the heat receiving part 32. A line of ‘cooling position b’ illustrates a case in which an outer wall of the casing 121 where the developer is conveyed to parallel direction (the region enclosed a dashed line b in FIG. 7) contacts the heat receiving part 32. A line of ‘without liquid cooling device’ illustrates a case in which the heat receiving part does not contact the casing 121.

In the lines of ‘cooling position a’ and ‘cooling position b’, areas of the contacting surface that contacted to the heat receiving part are the same. As shown in FIG. 25, when the areas are the same, ‘cooling position a’ cools more than the ‘cooling position b’.

FIG. 1 is an enlarged view of the developing device 40 of this embodiment. The gap adjusting member 112 opposing the developing roller 45 move downstream in a rotating direction of the developing sleeve 45a than the developing area is separated from the casing 121 as shown FIG. 1. The gap adjusting member 112 includes a developing roller opposing part 112a opposing the developing roller 45 and elongating in the longitudinal direction. The developing roller opposing part 112a is opposing the developing roller 45 and has a curved surface along the developing roller 45.

A length of longitudinal direction of the developing roller opposing part 112a is longer than the length of the developer carried region 45c. Therefore the case gap where the pumping air flow is caused by the magnetic brush is adjusted properly.

The gap adjusting member 112 is made of conductive material. In this embodiment, the adjusting member 112 is cut aluminum. In this embodiment, the gap adjusting member 112 is preferably made of metal, although other implementations are possible.

When the casing 121 of the developing device 40 is made of metal, a heat of the developer is effectively transmitted to the heat receiving part 32 of the liquid cooling device 30 via the casing. The developer in the developing device 40 is effectively cooled by the liquid cooling device 30.

The heat receiving part 32 is made of metal and is disposed in the liquid cooling device 30. The heat receiving part is grounded by connecting it to the image forming apparatus. The metal casing 121 contacts the heat receiving part 32 which is also grounded. Alternatively, the casing 121 may be connected to the image forming apparatus directly and grounded (not via the heat receiving part 32).

When the casing 121 is grounded and connected to the gap adjusting member 112 electrically, the gap adjusting member 112 is grounded too. In this case, when the conductor (such as a metallic powder) is filled between the developing roller 45 and the gap adjusting member 112, current flows from the developing roller 45 to the gap adjusting member 112 via the conductor.

In this embodiment, an insulation tape 123 which is an insulation member, is disposed at a part where the gap adjusting member 112 is opposing to the casing 121 or a part where the adjusting member 112 closes to the casing 121. The insulating tape 123 is elongated along whole area of an attached area 121A where the gap adjusting member 112 is attached. The insulating tape is attached to an attached surface 121Aa, 121Ab of attached area 121A.

In the developer of this embodiment, the gap adjusting member 112 is insulated from the casing 121 through an insulation tape 123. The gap adjusting member is in a float state as floating electrically, and the casing is grounded. Therefore when the conductor, such as a metallic powder, is filled between the developing roller 45 and the gap adjusting member 112, a current is prevented from flowing from the developing roller 45 to the gap adjusting member 112 via the conductor.

The insulation member has a higher insulating property than the gap adjusting member 112. The insulation member has an insulating property such that the current leaked from the developing roller 45 does not flow to the casing 121.

In this embodiment, the insulation tape 123 is made of resin, for example Teflon®, silicone rubber, and so on. The insulation tape 123 has a high electrical resistance. There are sponge seals 131 at the end of the longitudinal direction of the gap adjusting member 112. The sponge seal 131 is made of insulation material which has a high electrical resistance. (Resin i.e. silicone rubber, sponge made of ethylene-propylene rubber and so on.)

When the gap adjusting member 112 is attached to the casing 121, a gauge, such as a feeler gauge, which has a thickness that is the same as a predetermined width of the gap is sandwiched between the developing roller 45 and the gap adjusting member 112 to adjust the width of the gap. After the gap adjusting member 112 is attached to the casing 121, the gage is removed. The gap between the gap adjusting member 112 and the casing 121 is adjusted. Therefore the gap is adjusted, even if the insulation tape 123 is disposed between the gap adjusting member 112 and the casing 121.

The gap adjusting member 112 is fixed by a screw or tape to the casing. The gap adjusting member 112 and the casing 121 are not brought into conduction, because the screw is made of high insulating resin, or the tape is made of insulation tape. Furthermore when a metal screw is used to fix the gap adjusting member 112, an insulation washer is sandwiched between the screw and the gap adjusting member 112.

### Comparative Example

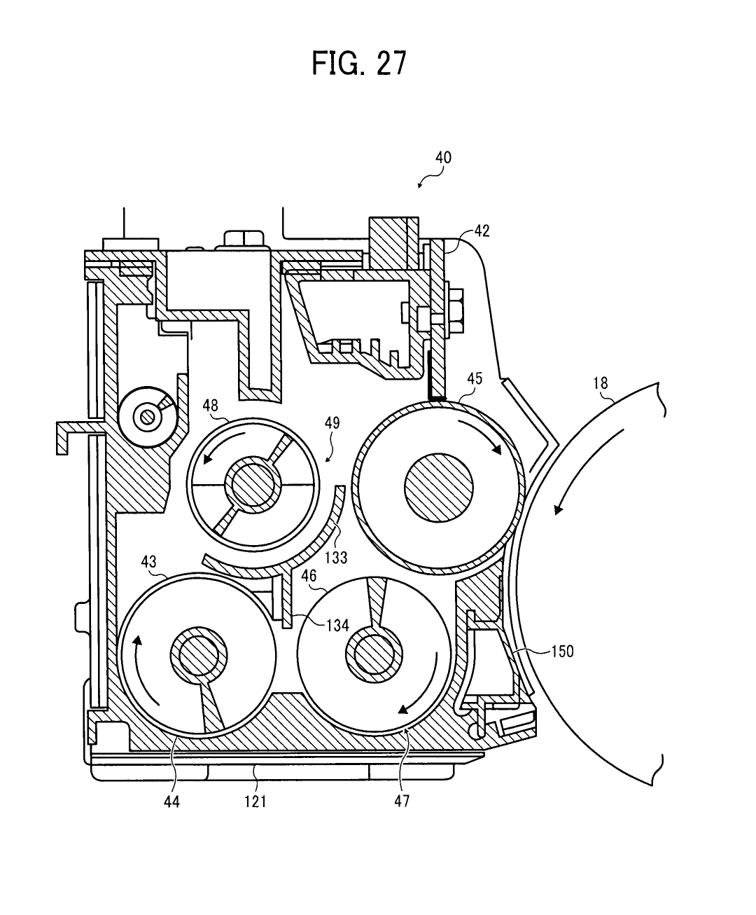

FIG. 27 is cross section view of the developer of the comparative example. The developing device does not have the gap adjusting member 112, and the casing is made by integrally molding. The developing device is made of aluminum, and the developing device contacts the heat receiving part 32.

In this comparative example, the casing is grounded via the heat receiving part. Thus, the electric field where the toner moves from developing roller to the casing, and scattering toner occurs at developing area is attracted to the casing by the electric field, and the toner is attached to the outer wall of the casing.

### Second Embodiment

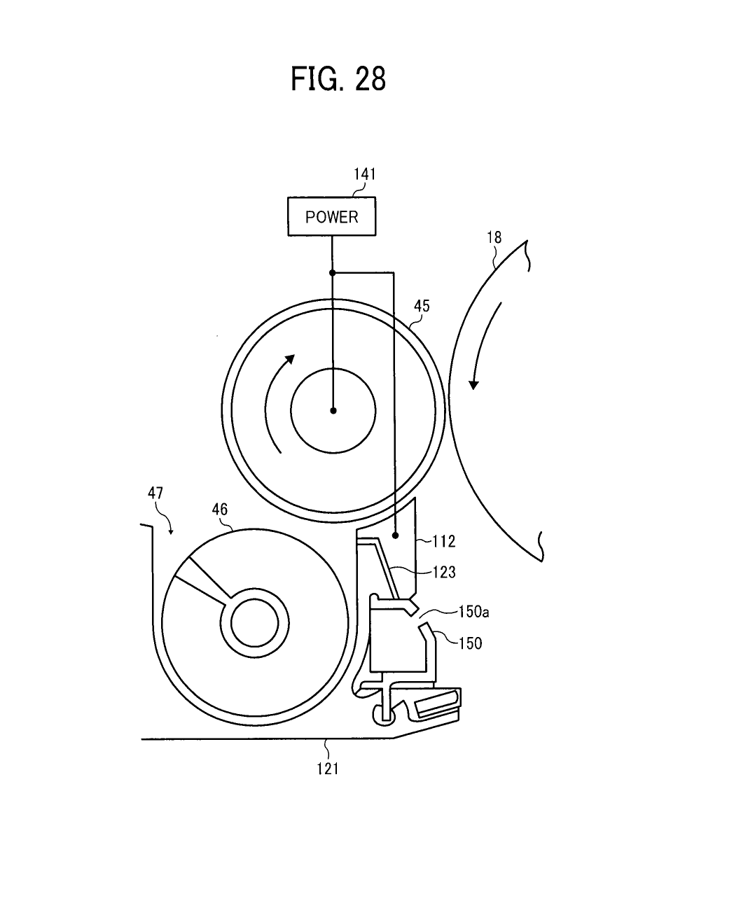

FIG. 28 is an enlarged view of the developing device of second embodiment. In this embodiment, a developing bias having a same polarity and the normal charge polarity of the toner is applied to the developing roller from a power supply 141. Also, a bias having the same potential as the developing bias is applied to the gap adjusting member from the power supply 141. The gap adjusting member is charged to the same polarity as the toner. Since a repulsive force occurs between the toner and the gap adjusting member, the toner is prevented from being attached to the outer wall of the gap adjusting member 112. Further, a bias having the same potential as the developing bias is applied to the gap adjusting member from the power supply 141, and the current is prevented from leaking between the developing roller 45 and the gap adjusting member 112.

In this embodiment, the insulation tape 123 is disposed between the gap adjusting member 112 and the casing 121, and the gap adjusting member 112 is insulated from the casing 121. So, the bias applied to the gap adjusting member 112 does not flow to the casing 121.

### Third Embodiment

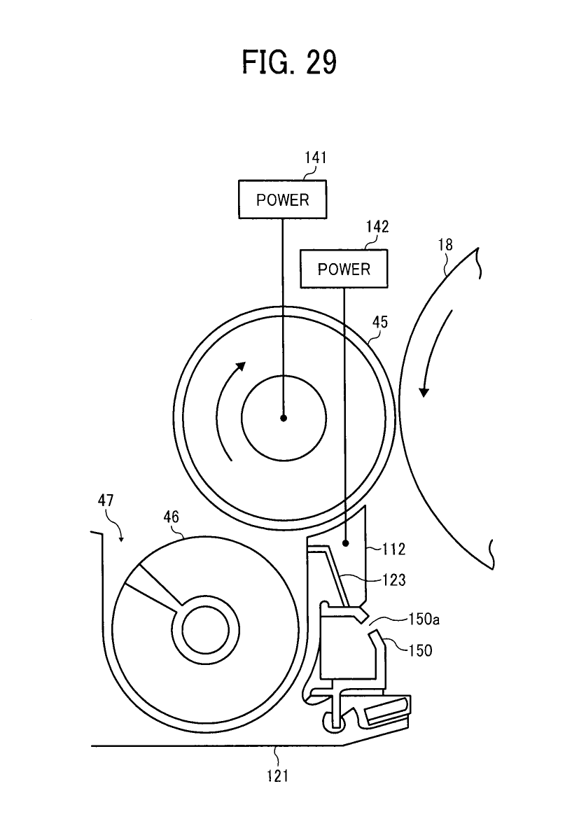

FIG. 29 is an enlarged view of the developing roller of the third embodiment. In this embodiment, a bias is applied from a power supply 142 which is different from the power supply 141 supplying to developing roller, to the gap adjusting member 112. Further, a bias whose absolute value of same polarity and normal charge polarity of the toner is higher than the developing bias which is applied to the gap adjusting member 112. Therefore the repulsive force between the scattering toner and the gap adjusting member 112 increases. The toner is prevented from being attached to the gap adjusting member 112.

When the bias is applied to the gap adjusting member 112 from the power supply 142 which is different from the power supply 142 applying the developing bias to the developing roller 45, the bias which is the same potential as the developing bias may be applied. Therefore, the developing roller 45 and the gap adjusting member 112 will be same potential, and the current is prevented to leak between the developing roller 45 and the gap adjusting member 112.

### Fourth Embodiment

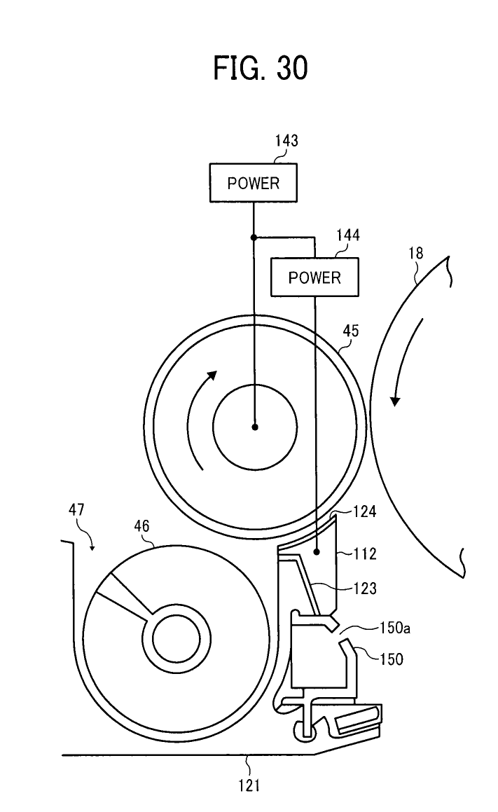

FIG. 30 is an enlarged view of the developing roller 45 of the fourth embodiment. In this embodiment, a superposing bias where DC component and AC component are superposed is applied from the power supply 143 to the developing roller 45 as a developing bias. A constant DC bias having the same polarity and the normal charge polarity of the toner is applied from the power supply 143 outputting the superposing bias via a rectifier.

In this embodiment, an insulating coating layer 124 is disposed at a part of the gap adjusting member 112 where opposed to the developing roller. A gap between the developing roller 45 and the gap adjusting member 112 is insulated by the insulating coating layer 124. Therefore a bias leak and an insulation breakdown are prevented from occurring. The insulating coating layer 124 is made of PET (polyethylene terephthalate) film which has 1.0 mm thickness.

### Fifth Embodiment

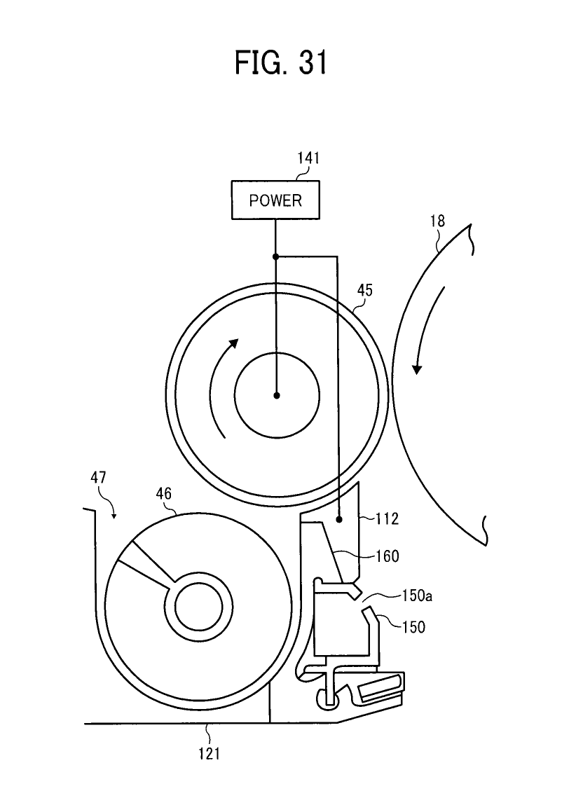

FIG. 31 is an enlarged view of developing roller of the fifth embodiment. A block 160 which is made of an insulating resin is disposed between the casing 121 and the gap adjusting member 112.

As shown in FIG. 31, an under part of the block 160 is fixed at the casing 121, and the gap adjusting member 112 is fixed at an upper part of the block 160. The block is disposed at the gap adjusting member 112 and the casing 121. Therefor the gap adjusting member 112 is insulated from the casing 121 by the block which is insulation. Current is prevented from flowing from the gap adjusting member 112 which receives the bias, to the casing which is grounded.

The distance between the gap adjusting member 112 and the casing 121 may be wider than the situation in which the insulation tape 123 is between the gap adjusting member 112 and the casing 121.

The insulating coating layer 124 may be disposed at a part of the gap adjusting member 112 opposed to the developing roller, like the fourth embodiment.

Obviously, numerous modifications and variations of the present invention are possible in light of the above teachings. It is therefore to be understood that within the scope of the appended claims, the invention may be practiced otherwise than as specifically described herein.

What is claimed is:

1. A developing device for use with developer including toner, comprising:
a rotatable developer carrier to carry the developer to an image forming area opposing to a latent image bearing member;
a development casing to store the developer;
a developing bias applying member to apply a developing bias to the developer carrier;
a contacting part to contact a contacting member grounded electrically and disposed at the development casing, and
a gap adjusting member to form a gap between the gap adjusting member and the developing carrier and disposed at a position which is downstream of a position of exposure of the developer carrier, relative to a rotating direction of the developer carrier,
wherein the development casing comprises walls which include an electrically conductive material, and an insulation member to insulate the gap adjusting member from the development casing is disposed between the gap adjusting member and the development casing.

2. The developing device according to claim 1, further comprising:
including a bias applying member to apply a bias that is a same polarity and the normal charge polarity as the toner to the gap adjusting member.

3. The developing device according to claim 2, wherein the bias applied to the gap adjusting member is a same potential as the developing bias.

4. The developing device according to claim 2, wherein the gap adjusting member has a bias applied thereto whose absolute value of the same polarity and the normal charge polarity of the toner is higher than the developing bias.

5. The developing device according to claim 1, further comprising:
an insulating layer at a part of the gap adjusting member opposite to the developer carrier.

6. The developing device according to claim 1, wherein the insulation member includes an insulation tape.

7. The developing device according to claim 1, wherein the insulation member includes resin.

8. The developing device according to claim 1, wherein the contacting member includes a heat receiving part of a cooling device.

9. The developing device according to claim 8, further comprising
a partition member to partition an inner space of the development casing into an upper developer conveyance path and a lower developer conveyance path;
an upper developer conveyer disposed in the upper developer conveyance path;
a lower developer conveyer disposed in the lower developer conveyance path; and
an opening through which the upper developer conveyance path and the lower developer conveyance path communicate, the opening disposed at a downstream side of developer conveyance direction of the lower developer conveyance path,
wherein the contacting part is disposed at an outside wall of the development casing of the downstream position.

10. The developing device according to claim 1, wherein the development casing and the gap adjusting member are made of metal.

11. An image forming apparatus comprising:
a developing device according claim 1,
wherein the contacting member contacts the developing device.
